(19) United States
(12) Patent Application Publication
(10) Pub. No.: US 2026/0095946 A1
(43) Pub. Date: Apr. 2, 2026

(54) SETS OF RANDOM ACCESS CHANNEL OCCASIONS ACROSS SUBBAND FULL DUPLEX (SBFD) SYMBOLS AND NON-SBFD SYMBOLS

(71) Applicant: QUALCOMM Incorporated, San Diego, CA (US)

(72) Inventors: Muhammad Sayed Khairy ABDELGHAFFAR, San Jose, CA (US); Ahmed Attia ABOTABL, San Diego, CA (US); Jae Ho RYU, San Diego, CA (US); Qian ZHANG, Basking Ridge, NJ (US)

(21) Appl. No.: 18/899,041

(22) Filed: Sep. 27, 2024

(51) Int. Cl. H04W 74/0833; H04L 5/14; H04W 8/22

(52) U.S. Cl. CPC H04W 74/0833; H04L 5/14; H04W 8/22

(57) ABSTRACT

Various aspects of the present disclosure generally relate to wireless communication. In some aspects, a user equipment (UE) may identify a set of random access channel (RACH) occasions (ROs) associated with a physical random access channel (PRACH) with preamble repetitions in the set of ROs, wherein: the set of ROs include a subband full duplex (SBFD) RO associated with one or more SBFD symbols and a non-SBFD RO associated with one or more non-SBFD symbols, and the set of ROs span across the one or more SBFD symbols and the one or more non-SBFD symbols. The UE may transmit a RACH transmission with preamble repetitions based at least in part on the set of ROs. Numerous other aspects are described.

### FIELD OF THE DISCLOSURE

Aspects of the present disclosure generally relate to wireless communication and specifically relate to techniques, apparatuses, and methods associated with sets of random access channel occasions across subband full duplex (SBFD) symbols and non-SBFD symbols.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

In some implementations, a method of wireless communication performed by a user equipment (UE) includes identifying a set of random access channel (RACH) occasions (ROs) associated with a physical random access channel (PRACH) with preamble repetitions in the set of ROs, wherein: the set of ROs include a subband full duplex (SBFD) RO associated with one or more SBFD symbols and a non-SBFD RO associated with one or more non-SBFD symbols, and the set of ROs span across the one or more SBFD symbols and the one or more non-SBFD symbols; and transmitting a RACH transmission with preamble repetitions based at least in part on the set of ROs.

In some implementations, a method of wireless communication performed by a network node includes transmitting a capability signaling; and receiving, based at least in part on the capability signaling, a RACH transmission with preamble repetitions based at least in part on a set of ROs, wherein: the set of ROs are associated with a PRACH with preamble repetitions in the set of ROs; the set of ROs include an SBFD RO associated with one or more SBFD symbols and a non-SBFD RO associated with one or more non-SBFD symbols, and the set of ROs span across the one or more SBFD symbols and the one or more non-SBFD symbols.

In some implementations, an apparatus for wireless communication at a UE includes one or more memories; and one or more processors, coupled to the one or more memories, which, individually or in any combination, are operable to cause the apparatus to: identify a set of ROs associated with a PRACH with preamble repetitions in the set of ROs, wherein: the set of ROs include an SBFD RO associated with one or more SBFD symbols and a non-SBFD RO associated with one or more non-SBFD symbols, and the set of ROs span across the one or more SBFD symbols and the one or more non-SBFD symbols; and transmit a RACH transmission with preamble repetitions based at least in part on the set of ROs.

In some implementations, an apparatus for wireless communication at a network node includes one or more memories; and one or more processors, coupled to the one or more memories, which, individually or in any combination, are operable to cause the apparatus to: transmit a capability signaling; and receive, based at least in part on the capability signaling, a RACH transmission with preamble repetitions based at least in part on a set of ROs, wherein: the set of ROs are associated with a PRACH with preamble repetitions in the set of ROs; the set of ROs include an SBFD RO associated with one or more SBFD symbols and a non-SBFD RO associated with one or more non-SBFD symbols, and the set of ROs span across the one or more SBFD symbols and the one or more non-SBFD symbols.

In some implementations, a non-transitory computer-readable medium storing a set of instructions for wireless communication includes one or more instructions that, when executed by one or more processors of a UE, cause the UE to: identify a set of ROs associated with a PRACH with preamble repetitions in the set of ROs, wherein: the set of ROs include an SBFD RO associated with one or more SBFD symbols and a non-SBFD RO associated with one or more non-SBFD symbols, and the set of ROs span across the one or more SBFD symbols and the one or more non-SBFD symbols; and transmit a RACH transmission with preamble repetitions based at least in part on the set of ROs.

In some implementations, a non-transitory computer-readable medium storing a set of instructions for wireless communication includes one or more instructions that, when executed by one or more processors of a network node, cause the network node to: transmit a capability signaling; and receive, based at least in part on the capability signaling, a RACH transmission with preamble repetitions based at least in part on a set of ROs, wherein: the set of ROs are associated with a PRACH with preamble repetitions in the set of ROs; the set of ROs include an SBFD RO associated with one or more SBFD symbols and a non-SBFD RO associated with one or more non-SBFD symbols, and the set of ROs span across the one or more SBFD symbols and the one or more non-SBFD symbols.

In some implementations, an apparatus for wireless communication includes means for identifying a set of ROs associated with a PRACH with preamble repetitions in the set of ROs, wherein: the set of ROs include an SBFD RO associated with one or more SBFD symbols and a non-SBFD RO associated with one or more non-SBFD symbols, and the set of ROs span across the one or more SBFD symbols and the one or more non-SBFD symbols; and means for transmitting a RACH transmission with preamble repetitions based at least in part on the set of ROs.

In some implementations, an apparatus for wireless communication includes means for transmitting a capability signaling; and means for receiving, based at least in part on the capability signaling, a RACH transmission with preamble repetitions based at least in part on a set of ROs, wherein: the set of ROs are associated with a PRACH with preamble repetitions in the set of ROs; the set of ROs include an SBFD RO associated with one or more SBFD symbols and a non-SBFD RO associated with one or more non-SBFD symbols, and the set of ROs span across the one or more SBFD symbols and the one or more non-SBFD symbols.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network in accordance with the present disclosure.

FIG. 2 is a diagram illustrating an example disaggregated base station architecture, in accordance with the present disclosure.

FIG. 3 is a diagram illustrating an example of random access channel occasion (RO) groups, in accordance with the present disclosure.

FIG. 4 is a diagram illustrating an example of a physical random access channel (PRACH) repetition, in accordance with the present disclosure.

FIG. 5 is a diagram illustrating an example of additional ROs in subband full duplex (SBFD) symbols, in accordance with the present disclosure.

FIG. 6 is a diagram illustrating an example of configuring ROs in SBFD symbols, in accordance with the present disclosure.

FIG. 7 is a diagram illustrating an example of configuring ROs in SBFD symbols, in accordance with the present disclosure.

FIG. 8 is a diagram illustrating an example of a PRACH repetition and an SBFD operation, in accordance with the present disclosure.

FIG. 9 is a diagram illustrating an example of a PRACH repetition and an SBFD operation, in accordance with the present disclosure.

FIGS. 10-16 are diagrams illustrating examples associated with RO groups across SBFD symbols and non-SBFD symbols, in accordance with the present disclosure.

FIG. 17 is a flowchart illustrating an example process performed, for example, by a user equipment, in accordance with the present disclosure.

FIG. 18 is a flowchart illustrating an example process performed, for example, by a network node, in accordance with the present disclosure.

FIGS. 19-20 are diagrams of example apparatuses for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A full duplex (FD) operation may involve an in-band full duplex (IBFD) operation, in which a transmission and a reception may occur on the same time and frequency resource. A downlink direction and an uplink direction may share the same IBFD time/frequency resource based at least in part on a full or partial overlap. Alternatively, the FD operation may involve a subband full duplex (SBFD) operation (or flexible duplex), in which a transmission and a reception may occur at the same time but on different frequency resources. A downlink resource may be separated from an uplink resource in a frequency domain. In the SBFD operation, no downlink and uplink overlap in frequency may occur.

An SBFD operation may increase an uplink duty cycle, which may result in a latency reduction (e.g., a downlink signal may be received in uplink-only slots, which may enable latency savings) and uplink coverage improvement. The SBFD operation may improve a system capacity, resource utilization, and/or spectrum efficiency. The SBFD operation may enable a flexible and dynamic uplink/downlink resource adaption according to uplink/downlink traffic in a robust manner.

A user equipment (UE) may transmit a physical random access channel (PRACH transmission) in accordance with a physical random access procedure. The UE may transmit the PRACH transmission in accordance with a configuration. The configuration may indicate a preamble index, a preamble subcarrier spacing (SCS), a PRACH target transmission power, a corresponding random access radio network temporary identifier (RA-RNTI) when applicable, and/or a PRACH resource for the cell. The configuration may indicate a number of preamble repetitions for the PRACH transmission. The number of preamble repetitions may be associated with a PRACH transmission repetition. The UE may transmit the PRACH transmission with repetition during one or more random access channel (RACH) occasions (ROs), which may be based at least in part on the configuration. The one or more ROs (or set of ROs) may be associated with an RO group.

The RO group may be formed across non-SBFD ROs and SBFD ROs, which may reduce a latency of PRACH repetition as compared to a time division duplexing (TDD) system, and which may enable a larger repetition within a same period as compared to a TDD-only (or SBFD-only) PRACH repetition. However, an uplink signal-to-interference-plus-noise ratio (SINR) may be different in SBFD and TDD, which may result in difficulty in predicting a number of repetitions required to achieve a certain combining gain. Further, the non-SBFD ROs and the SBFD ROs may have a same or different association period and/or association period pattern, which may result in difficulty in determining a repetition time period. When the RO group is formed with an unfavorable number of repetitions and/or an unfavorable repetition time period, the RO group may be associated with increased latency and/or an insufficient number of repetitions as compared to the TDD system, thereby reducing an overall system performance.

Various aspects relate generally to RO groups associated with RACH transmission with preamble repetitions in the ROs within the RO group. Some aspects more specifically relate to RO groups across SBFD symbols and non-SBFD symbols, where the RO groups may be associated with RACH transmissions. An “RO group” may be used interchangeably with a “set of ROs” herein. In some examples, a UE may identify an RO group associated with a PRACH repetition. The PRACH repetition may be a PRACH transmission with preamble repetitions in the RO group. The RO group may include an SBFD RO associated with one or more SBFD symbols and a non-SBFD RO associated with one or more non-SBFD symbols. The RO group may span across the one or more SBFD symbols and the one or more non-SBFD symbols. In some aspects, a starting frequency resource (e.g., a starting resource block (RB) or a starting physical resource block (PRB)) of the SBFD RO may be based at least in part on the start frequency resource (RB) of the non-SBFD RO, such that the SBFD RO is associated with a same virtual starting RB and a different physical starting RB. In other words, the SBFD RO may have the same virtual start RB as the non-SBFD RO, but a physical start PRB may be different between the SBFD RO and the non-SBFD RO. The virtual start RB may be the same due to a same interpretation with respect to a first RB in an uplink BWP (for non-SBFD RO) and a first RB in an uplink subband (for SBFD RO).

In some aspects, the starting RB of the SBFD RO may be based at least in part on an RB offset and a starting RB of the non-SBFD RO. In some aspects, the starting RB of the SBFD RO may be based at least in part on the RB offset and/or a starting RB of the non-SBFD RO, where the starting RB of the SBFD RO may be based at least in part on a modular operation with respect to a number of useable uplink physical resource blocks (PRBs) in an uplink subband. In some aspects, the RO group may include a number of SBFD ROs and a number of non-SBFD ROs, where the number of non-SBFD ROs may be at least one half of a total number of ROs in the RO group, and where a repetition of the non-SBFD RO may be counted as one and a repetition of the SBFD RO may be counted as less than one, which may be due to different link qualities and expected combining gains of repetitions of SBFD symbols versus non-SBFD symbols. In addition, the UE may transmit, to a network node, a RACH transmission with preamble repetitions based at least in part on the RO group.

In some aspects, the RO group for PRACH repetition may be formed across SBFD symbols/slots and non-SBFD symbols/slots. The RO group may also be referred to as a mixed RO group because the RO group may contain both SBFD ROs and legacy ROs (e.g., non-SBFD ROs). An efficient PRACH repetition across SBFD symbols and non-SBFD symbols may be enabled based at least in part on several design considerations. A first design consideration may involve a configuration of a number of repetitions in the SBFD symbols and the non-SBFD symbols given a different link quality and an expected combining gain of repetitions. A second design consideration may involve a determination of a first RO in an RO group across the legacy ROs and the SBFD ROs. A third design consideration may involve a differentiation of SBFD-aware UEs and legacy UEs that are transmitting a preamble with repetitions in shared legacy ROs.

Particular aspects of the subject matter described in this disclosure can be implemented to realize one or more of the following potential advantages. In some examples, by configuring RO groups across SBFD symbols and non-SBFD symbols, the described techniques can be used by the UE to transmit RACH transmissions with efficient PRACH repetition. An RO group in the SBFD symbols and the non-SBFD symbols may have different starting RBs, which may increase a design flexibility. A number of repetitions in the SBFD symbols and a number of repetitions in the non-SBFD symbols may be selected depending on different link qualities and expected combining gains of repetitions of SBFD symbols versus non-SBFD symbols, which may allow numbers of desired repetitions to be more accurately predicted. The RO groups may be enabled across legacy/TDD ROs and SBFD ROs, which may reduce a latency of PRACH repetition as compared to a TDD system, and which may enable a larger repetition within a same period as compared to a TDD-only (or SBFD-only) PRACH repetition. As a result, the UE and/or the network node may be able to transmit and/or receive RACH transmissions with repetition using RO groups that are efficiently formed across the SBFD symbols and the non-SBFD symbols, thereby improving an overall system performance.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

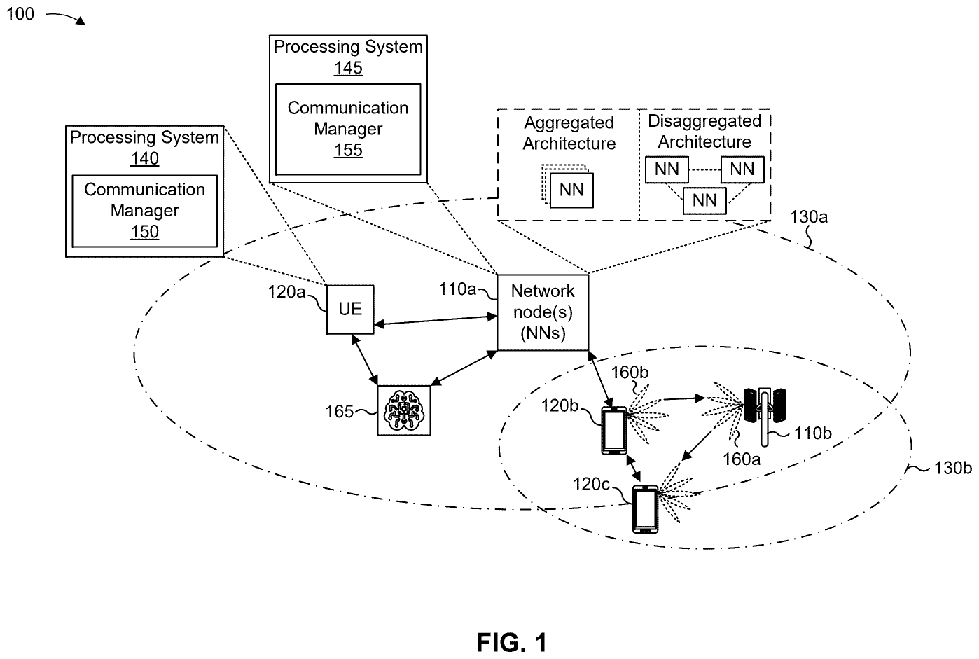

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

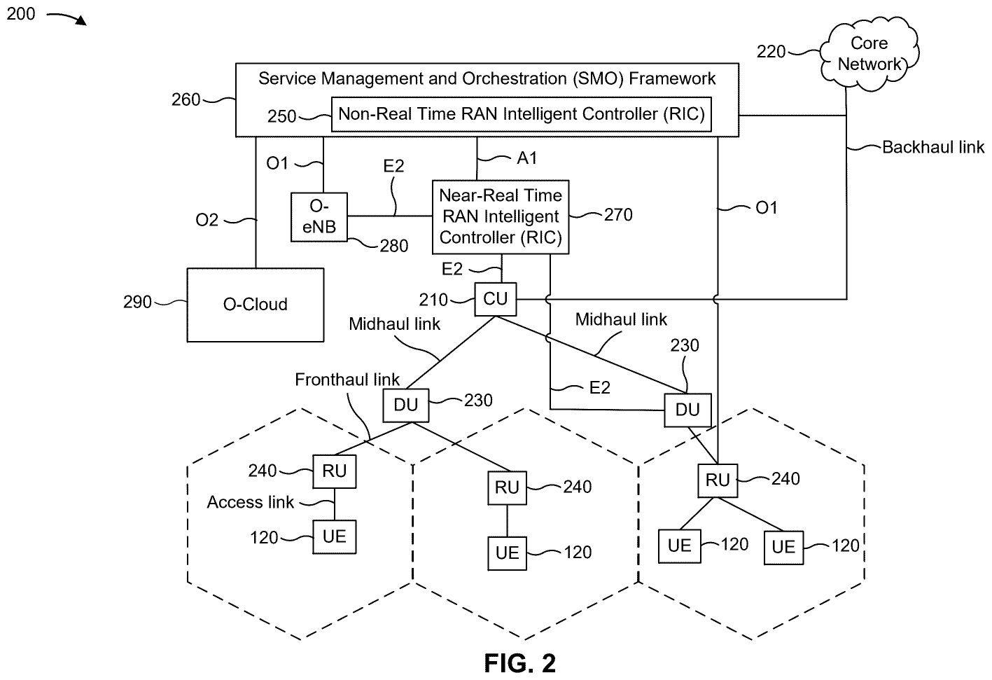

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or PRACH extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, smart jewelry, a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, RBs, and resource elements), and spatial domain resources (for example, particular transmit directions or beams).

Frequency domain resources may be subdivided into bandwidth parts (BWPs). A BWP may be a block of frequency domain resources (for example, a continuous set of RBs within a full component carrier bandwidth) that may be configured at a UE-specific level. A UE 120 may be configured with both an uplink BWP and a downlink BWP (which may be the same or different). Each BWP may be associated with its own numerology (indicating a SCS and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a RACH operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, a UE (e.g., the UE 120) may include a communication manager 150. As described in more detail elsewhere herein, the communication manager 150 may identify a set of ROs associated with a PRACH with preamble repetitions in the set of ROs, wherein: the set of ROs include an SBFD RO associated with one or more SBFD symbols and a non-SBFD RO associated with one or more non-SBFD symbols, and the set of ROs span across the one or more SBFD symbols and the one or more non-SBFD symbols; and transmit a RACH transmission with preamble repetitions based at least in part on the set of ROs. Additionally, or alternatively, the communication manager 150 may perform one or more other operations described herein.

In some aspects, a network node (e.g., the network node 110) may include a communication manager 155. As described in more detail elsewhere herein, the communication manager 155 may transmit a capability signaling; and receive, based at least in part on the capability signaling, a RACH transmission with preamble repetitions based at least in part on a set of ROs, wherein: the set of ROs are associated with a PRACH with preamble repetitions in the set of ROs; the set of ROs include an SBFD RO associated with one or more SBFD symbols and a non-SBFD RO associated with one or more non-SBFD symbols, and the set of ROs span across the one or more SBFD symbols and the one or more non-SBFD symbols. Additionally, or alternatively, the communication manager 155 may perform one or more other operations described herein.

As indicated above, FIG. 1 is provided as an example. Other examples may differ from what is described with regard to FIG. 1.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

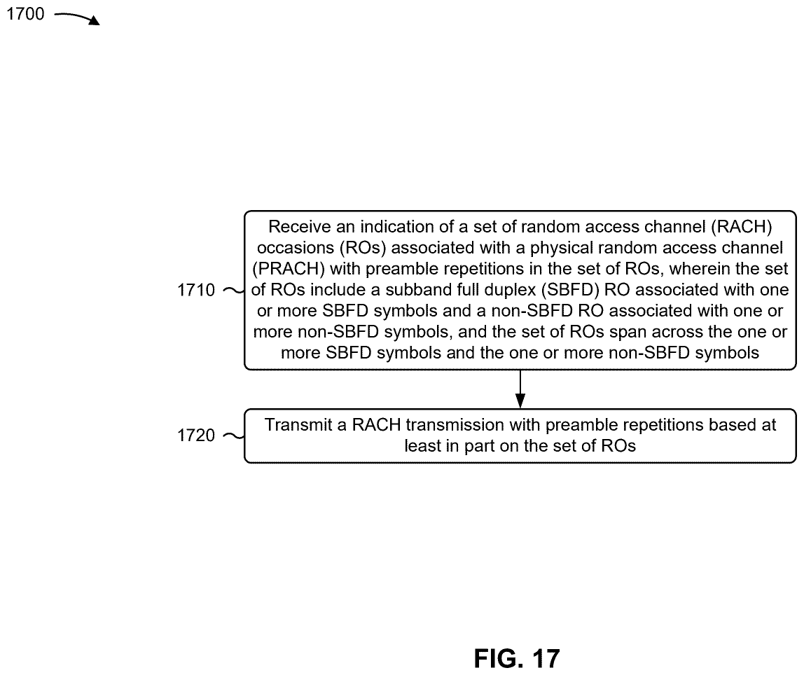

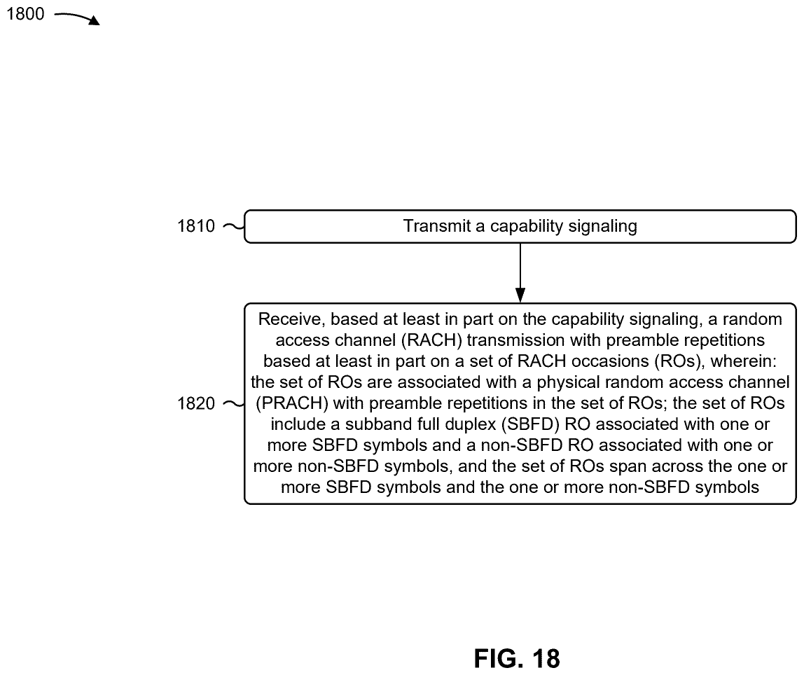

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with RO groups across SBFD symbols and non-SBFD symbols, as described in more detail elsewhere herein. For example, the processing system 145 of the network node 110, the processing system 140 of the UE 120, the CU 210, the DU 230, or the RU 240 may perform or direct operations of, for example, process 1700 of FIG. 17, process 1800 of FIG. 18, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1700 of FIG. 17, process 1800 of FIG. 18, or other processes as described herein. In some examples, executing instructions may include running the instructions, converting the instructions, compiling the instructions, and/or interpreting the instructions, among other examples.

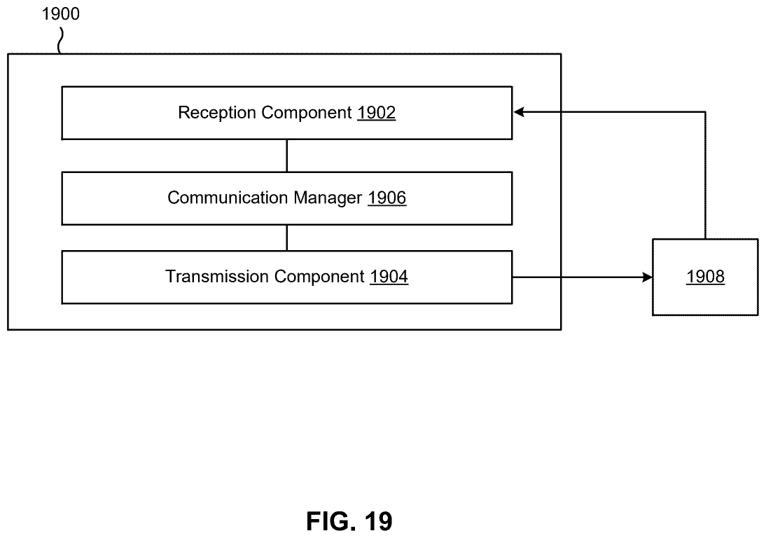

In some aspects, a UE (e.g., the UE 120) includes means for identifying a set of ROs associated with a PRACH with preamble repetitions in the set of ROs, wherein: the set of ROs include an SBFD RO associated with one or more SBFD symbols and a non-SBFD RO associated with one or more non-SBFD symbols, and the set of ROs span across the one or more SBFD symbols and the one or more non-SBFD symbols; and/or means for transmitting a RACH transmission with preamble repetitions based at least in part on the set of ROs. The means for the UE to perform operations described herein may include, for example, one or more of communication manager 150, processing system 140, a radio, one or more RF chains, one or more transceivers, one or more antennas, one or more modems, a reception component (for example, reception component 1902 depicted and described in connection with FIG. 19), and/or a transmission component (for example, transmission component 1904 depicted and described in connection with FIG. 19), among other examples.

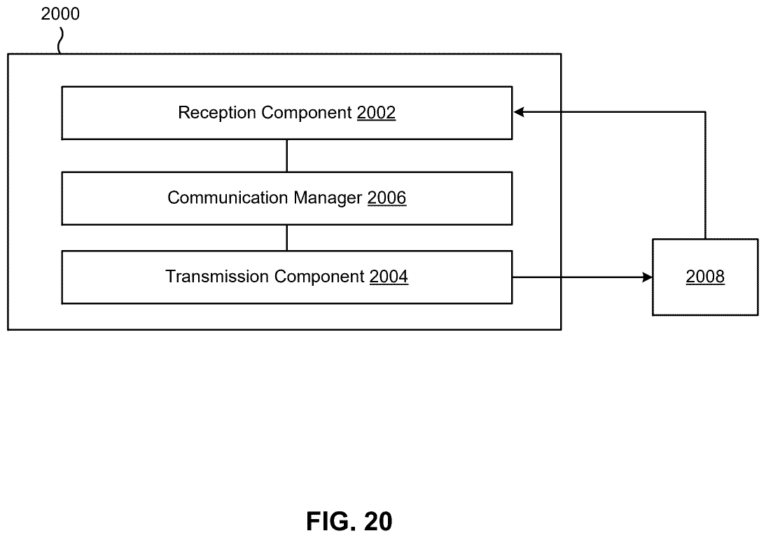

In some aspects, a network node (e.g., the network node 110) includes means for transmitting a capability signaling; and/or means for receiving, based at least in part on the capability signaling, a RACH transmission with preamble repetitions based at least in part on a set of ROs, wherein: the set of ROs are associated with a PRACH with preamble repetitions in the set of ROs; the set of ROs include an SBFD RO associated with one or more SBFD symbols and a non-SBFD RO associated with one or more non-SBFD symbols, and the set of ROs span across the one or more SBFD symbols and the one or more non-SBFD symbols. The means for the network node to perform operations described herein may include, for example, one or more of communication manager 155, processing system 145, a radio, one or more RF chains, one or more transceivers, one or more antennas, one or more modems, a reception component (for example, reception component 2002 depicted and described in connection with FIG. 20), and/or a transmission component (for example, transmission component 2004 depicted and described in connection with FIG. 20), among other examples.

As indicated above, FIG. 2 is provided as an example. Other examples may differ from what is described with regard to FIG. 2.

A physical random access procedure for a UE may be triggered upon a request of a PRACH transmission by higher layers or by a PDCCH order for a cell. A configuration by higher layers for a PRACH transmission may include a configuration for PRACH transmission on the cell. The configuration by the higher layers for the PRACH transmission may include a preamble index, a preamble SCS, a PRACH target transmission power (P_{PRACH,target}), a corresponding RA-RNTI when applicable, and/or a PRACH resource for the cell. The configuration by the higher layers for the PRACH transmission may include a number of

$${N}_{preamble}^{rep} > 1$$

preamble repetitions for the PRACH transmission when the UE is to transmit the PRACH transmission with repetitions, where

$${N}_{preamble}^{rep}$$

is a number of preamble repetitions. The number of preamble repetitions may be associated with a PRACH repetition.

The UE may transmit the PRACH transmission on the cell using a selected PRACH format with a transmission power P_{PRACH,b,f,c}(i) on an indicated PRACH resource or on a determined set of

$${N}_{preamble}^{rep}$$

resources using a same spatial filter in case of

$${N}_{preamble}^{rep}$$

preamble repetitions. For a PRACH transmission with

$${N}_{preamble}^{rep}$$

preamble repetitions, a set may include

$${N}_{preamble}^{rep}$$

valid PRACH occasions that are consecutive in time, use the same frequency resources, and/or are associated with the same synchronization signal (SS) or physical broadcast channel (PBCH) block indexes. Each SS/PBCH block index may be associated with the same preamble indexes in all valid PRACH occasions within the set.

For a PRACH transmission with preamble repetitions, a time period, starting from frame 0, may be a smallest integer number of association pattern periods, such that at least one set of valid PRACH occasions for each of the

$${N}_{Tx}^{SSB} SS / PBCH$$

block indexes can be determined within the time period for all configured numbers of preamble repetitions. One or more sets of valid PRACH occasions for each configured number of preamble repetitions may repeat every time period.

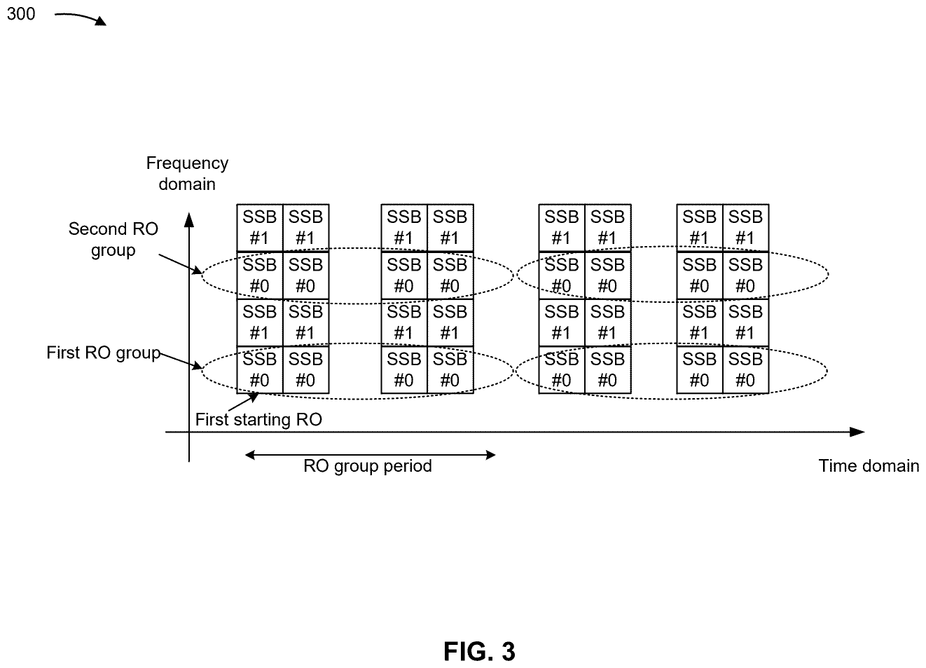

FIG. 3 is a diagram illustrating an example 300 of RO groups, in accordance with the present disclosure.

As shown in FIG. 3, multiple RO groups may be defined in a frequency domain and in a time domain. An RO group may be associated with a periodic pattern. The RO group may include a first starting RO. The RO group may be a set of

$${N}_{preamble}^{rep}$$

valid ROs, or PRACH occasions, that are consecutive in time and use the same frequency resources. When

$${N}_{preamble}^{rep} = 4 PRACH$$

repetitions, two SSBs (e.g., SSB #0 and SSB #1) may be used, each RO may have four frequency division multiplexed ROs (across RO groups), and an RO group may have four valid ROs.

As indicated above, FIG. 3 is provided as an example. Other examples may differ from what is described with regard to FIG. 3.

Random access may be defined for SBFD symbols. For an SBFD operation at a network node side within a TDD carrier, a semi-static indication of a time location of SBFD subbands to UEs in an RRC connected mode may be specified. An indication of a time location of SBFD subbands in a system information block (SIB) may not be precluded. A semi-static indication of a frequency domain location of SBFD subbands to UEs in the RRC connected mode may be specified. An indication of a frequency domain location of SBFD subbands in a SIB may not be precluded. An SBFD operation may be specified to support a random access in SBFD symbols by UEs in the RRC connected mode and UEs in an RRC idle/inactive mode.

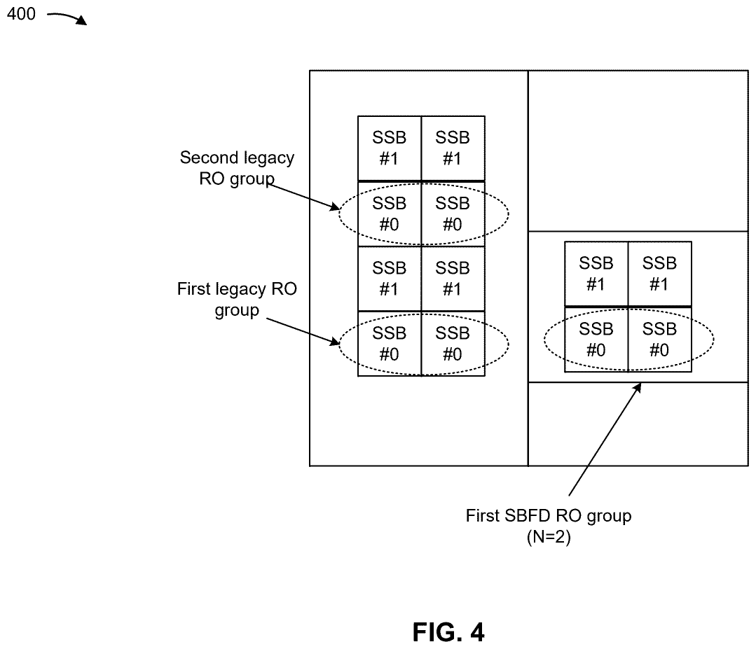

FIG. 4 is a diagram illustrating an example 400 of a PRACH repetition, in accordance with the present disclosure.

As shown in FIG. 4, for an SBFD aware UE, a PRACH transmission with preamble repetitions (PRACH repetition) within additional ROs may be supported (e.g., not across additional ROs and legacy ROs). The SBFD aware UEs may support PRACH transmission with preamble repetitions only within the legacy ROs (not across the additional ROs and the legacy ROs). For example, non-SBFD symbols may be associated with a first legacy RO group and a second legacy RO group, and SBFD symbols may be associated with an SBFD RO group

$$( e . g . , {N}_{preamble}^{rep} = 2 ) ,$$

such that preamble repetitions may not be across additional ROs and legacy ROs.

As indicated above, FIG. 4 is provided as an example. Other examples may differ from what is described with regard to FIG. 4.

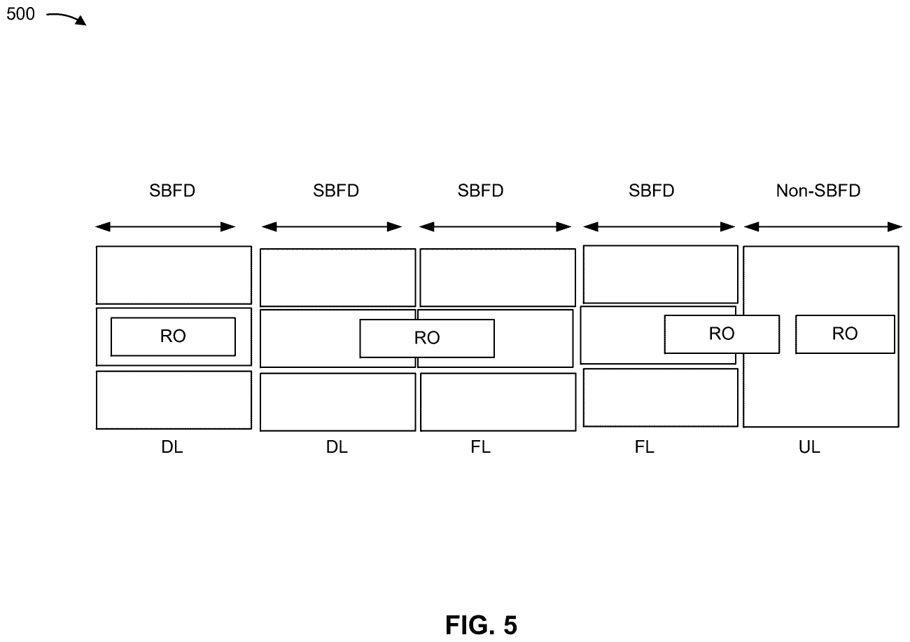

FIG. 5 is a diagram illustrating an example 500 of additional ROs in SBFD symbols, in accordance with the present disclosure.

As shown in FIG. 5, in a first RACH configuration, additional ROs may include ROs in SBFD symbols configured as downlink by a TDD uplink-downlink common configuration (tdd-UL-DL-ConfigurationCommon), and ROs across SBFD symbols configured as downlink and SBFD symbols configured as flexible by the TDD uplink-downlink common configuration. Alternatively, in a second RACH configuration, additional ROs may be ROs configured by an additional RACH configuration (not shown in FIG. 5).

As indicated above, FIG. 5 is provided as an example. Other examples may differ from what is described with regard to FIG. 5.

ROs may be configured in SBFD symbols. For a random access operation for SBFD-aware UEs, in a first option, one single RACH configuration with a possible enhancement may be used. ROs within an uplink subband in SBFD symbols may be valid for the SBFD-aware UE. In a second option, two separate RACH configurations may be used, including one legacy RACH configuration and one additional RACH configuration. ROs within an uplink subband in SBFD symbols configured by the additional RACH configuration may be valid for SBFD-aware UEs.

For SBFD-aware UEs in the RRC connected state and the RRC idle/inactive state, two RACH configurations may be supported. A first RACH configuration may involve using one single RACH configuration, and only based at least in part on existing parameters of the single RACH configuration. A second RACH configuration may involve using two separate RACH configurations, including one legacy RACH configuration and one additional RACH configuration. In some cases, enabling both RACH configurations at the same time for a UE may not be supported. For the first RACH configuration, a message 1 frequency start (msg1-FrequencyStart) in a common RACH configuration (rach-ConfigCommon) may be reinterpreted, validation rules may be defined, and/or SSB-RO mapping rules may be defined. For the second RACH configuration, RO validation rules may be defined, and/or SSB-RO mapping rules may be defined. In some cases, all parameters currently in the common RACH configuration may need to be included in the additional RACH configuration. The UE may not be required to support both the first RACH configuration and the second RACH configuration.

One RACH configuration for all symbol types may be associated with a single configuration, and no extra signaling may be required. A non-SBFD-aware UE may leverage random access in SBFD symbols. The one RACH configuration for all symbol types may be associated with the same RRC configuration as the common RACH configuration. Separate RACH configurations for each duplex types (e.g., RO-Confg1 for legacy operation and RO-Config2 for SBFD operation) may provide flexibility. Separate RACH configurations may have separate parameters, which may include a preamble, an RO time/frequency, resources, and/or a power configuration. The separate RACH configurations may be associated with extra configurations and/or overhead. SBFD ROs may only be applicable for SBFD-aware UEs.

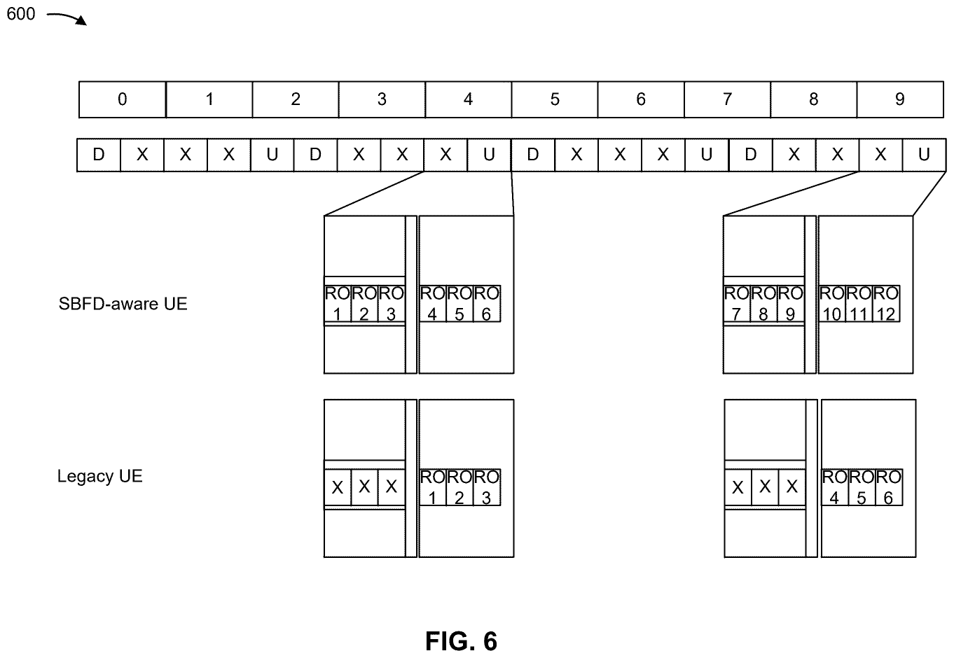

FIG. 6 is a diagram illustrating an example 600 of configuring ROs in SBFD symbols, in accordance with the present disclosure.

As shown in FIG. 6, one shared RACH configuration using a single PRACH configuration index may be employed to configure ROs in SBFD symbols. One single RACH configuration with an enhancement (validation rule) may be used for configuring the ROs in the SBFD symbols. The ROs may be configured in SBFD symbols for both SBFD-aware UEs and legacy UEs (e.g., non-SBFD-aware UEs). The one shared RACH configuration (or one single RACH configuration) may be associated with the single PRACH configuration index, a preamble format, a subframe number, a starting symbol, a number for PRACH slots within a subframe, a number of time domain PRACH occasions within a PRACH slot, and/or a PRACH duration.

As indicated above, FIG. 6 is provided as an example. Other examples may differ from what is described with regard to FIG. 6.

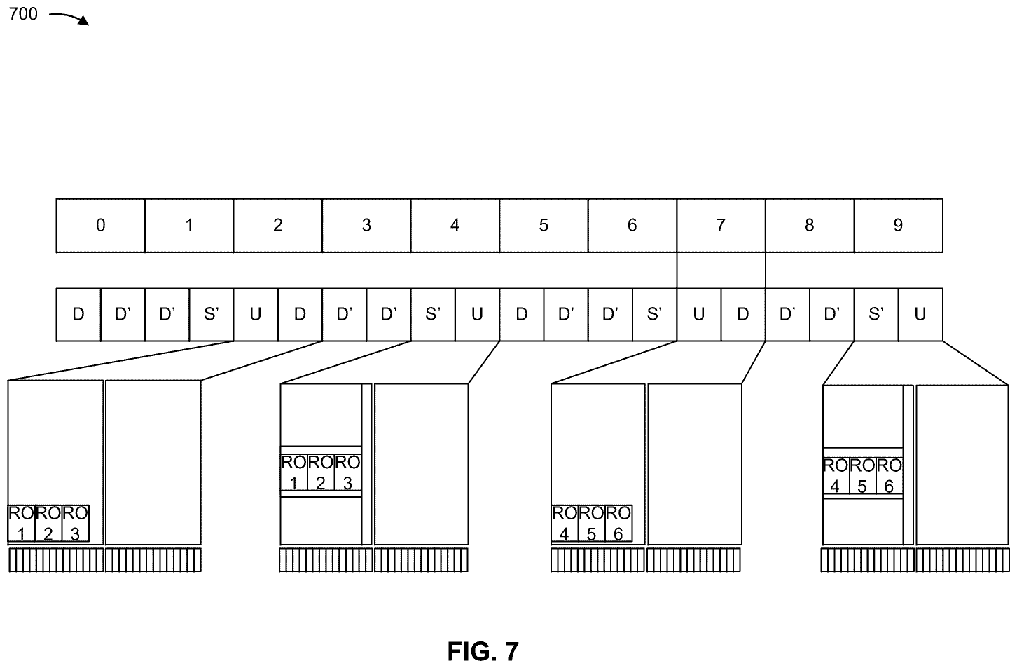

FIG. 7 is a diagram illustrating an example 700 of configuring ROs in SBFD symbols, in accordance with the present disclosure.

As shown in FIG. 7, two RACH configurations with separate PRACH configuration indices may be employed to configure ROs in SBFD symbols. Two separate RACH configurations, including one legacy RACH configuration and one additional RACH configuration, may be used for configuring the ROs in the SBFD symbols. The ROs may be configured in SBFD symbols for both SBFD-aware UEs and legacy UEs (e.g., non-SBFD-aware UEs). The two RACH configurations may each be associated with a PRACH configuration index, a preamble format, a subframe number, a starting symbol, a number for PRACH slots within a subframe, a number of time domain PRACH occasions within a PRACH slot, and/or a PRACH duration.

As indicated above, FIG. 7 is provided as an example. Other examples may differ from what is described with regard to FIG. 7.

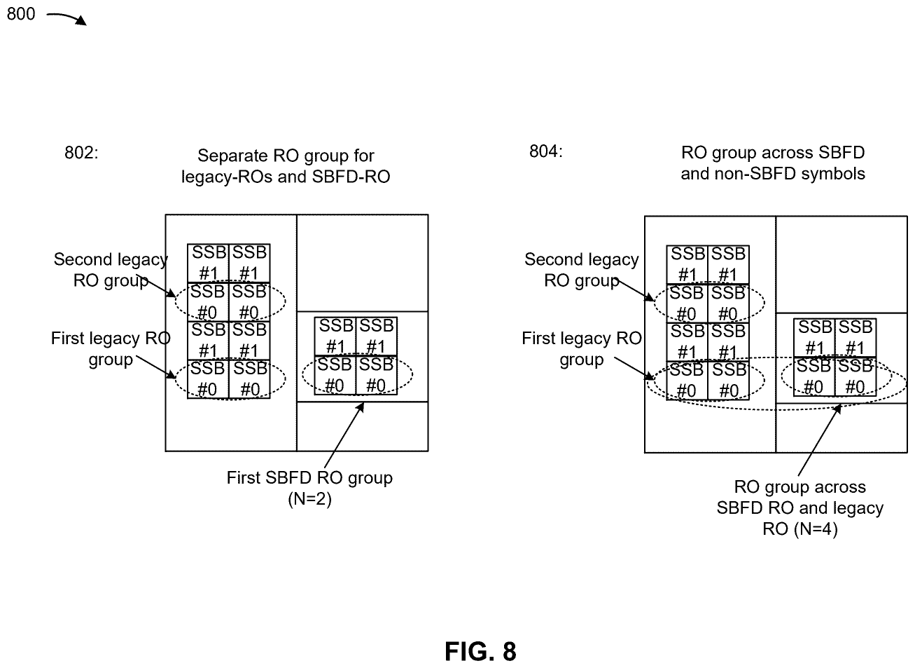

FIG. 8 is a diagram illustrating an example 800 of a PRACH repetition and an SBFD operation, in accordance with the present disclosure.

As shown by reference number 802, for the PRACH repetition and the SBFD operation, non-SBFD symbols may include one or more legacy RO groups, and SBFD symbols may include an SBFD RO group

$$( e . g . , {N}_{preamble}^{rep} = 2 ) .$$

In this example, separate RO groups may be defined for legacy ROs and SBFD ROs.

As shown by reference number 804, for the PRACH repetition and the SBFD operation, non-SBFD symbols may include one or more legacy RO groups, and an RO group may be across the non-SBFD symbols and SBFD symbols. In this example, the RO group (e.g., SSB #0) may be across two legacy-ROs in the non-SBFD symbols and the two additional ROs in the SBFD symbols

$$( e . g . , {N}_{preamble}^{rep} = 4 ) .$$

The RO group may be across an SBFD RO and a legacy RO.

As indicated above, FIG. 8 is provided as an example. Other examples may differ from what is described with regard to FIG. 8.

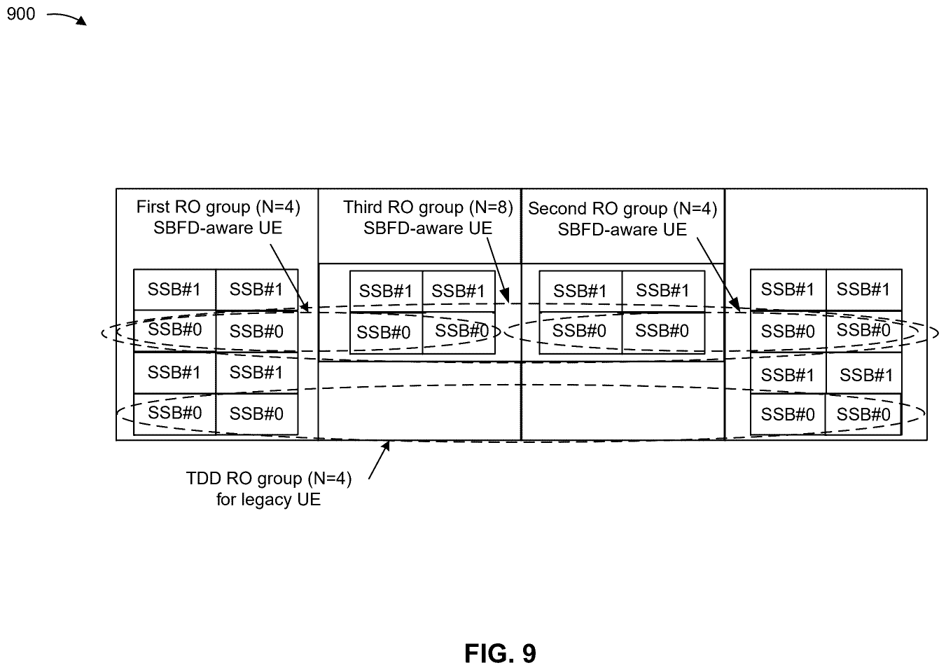

FIG. 9 is a diagram illustrating an example 900 of a PRACH repetition and an SBFD operation, in accordance with the present disclosure.

As shown in FIG. 9, for the PRACH repetition and the SBFD operation, RO groups may be across non-SBFD symbols and SBFD symbols. In this example, a first RO group

$$( e . g . , {N}_{preamble}^{rep} = 4 )$$

may be formed with two ROs in the non-SBFD symbols and two additional ROs in the SBFD symbols for SBFD-aware UEs. A second RO group

$$( e . g . , {N}_{preamble}^{rep} = 4 )$$

may be formed with two ROs in the non-SBFD symbols and two additional ROs in the SBFD symbols for SBFD-aware UEs, which may be different non-SBFD symbols and different SBFD symbols as compared to the first RO group. A third RO group

$$( e . g . , {N}_{preamble}^{rep} = 8 )$$

may be formed with two ROs in the non-SBFD symbols and two additional ROs in the SBFD symbols for SBFD-aware UEs. Further, a TDD RO group

$$( e . g . , {N}_{preamble}^{rep} = 4 )$$

may be across non-SBFD symbols for legacy UEs.

As indicated above, FIG. 9 is provided as an example. Other examples may differ from what is described with regard to FIG. 9.

An RO group may be enabled across legacy/TDD ROs and SBFD ROs, which may reduce a latency of PRACH repetition as compared to a TDD system, and which may enable a larger repetition within a same period as compared to a TDD-only (or SBFD-only) PRACH repetition. However, an uplink SINR may be different in SBFD and TDD, which may result in difficulty in predicting a number of repetitions to achieve a certain combining gain. Further, legacy ROs (TDD ROs) and the SBFD ROs (additional SBFD ROs) may have a same or different association period and/or association period pattern, which may result in difficulty in determining a repetition time period. When the RO group is formed with an unfavorable number of repetitions and/or an unfavorable repetition time period, the RO group may be associated with increased latency and/or smaller repetition as compared to the TDD system, thereby reducing an overall system performance.

In various aspects of techniques and apparatuses described herein, a UE may identify an RO group associated with a PRACH repetition. An “RO group” may be used interchangeably with a “set of ROs” herein. The PRACH repetition may be a PRACH with preamble repetitions in the RO group. The UE may receive, from a network node, a capability signaling. The capability signaling may indicate that the network node is capable of receiving a PRACH transmission with a number of preamble repetitions in the RO group that has a combination of non-SBFD ROs and SBFD ROs. The UE, based at least in part on the capability signaling received from the network node, may determine the RO group (e.g., legacy ROs and additional ROs) for PRACH transmission with preamble repetition.

In some aspects, the RO group may include an SBFD RO associated with one or more SBFD symbols and a non-SBFD RO associated with one or more non-SBFD symbols. The RO group may span across the one or more SBFD symbols and the one or more non-SBFD symbols. In some aspects, a starting RB of the SBFD RO may be based at least in part on the non-SBFD RO and the SBFD RO being associated with a same virtual starting RB and a different physical starting RB. In some aspects, the starting RB of the SBFD RO may be based at least in part on an RB offset and a starting RB of the non-SBFD RO. In some aspects, the starting RB of the SBFD RO may be based at least in part on the RB offset and/or a starting RB of the non-SBFD RO, where the starting RB of the SBFD RO may be based at least in part on a modular operation with respect to a number of useable uplink PRBs in an uplink subband. In some aspects, the RO group may include a number of SBFD ROs and a number of non-SBFD ROs, where the number of non-SBFD ROs may be at least one half of a total number of ROs in the RO group, and where a repetition of the non-SBFD RO may be counted as one and a repetition of the SBFD RO may be counted as less than one, which may be due to different link qualities and expected combining gains of repetitions of SBFD symbols versus non-SBFD symbols. In addition, the UE may transmit, to the network node, a RACH transmission with preamble repetitions based at least in part on the RO group.

In some aspects, the RO group for PRACH repetition may be formed across ROs in SBFD symbols/slots and ROs in non-SBFD symbols/slots. The RO group may also be referred to as a mixed RO group because the RO group may contain both SBFD ROs and legacy ROs (e.g., non-SBFD ROs). An efficient PRACH repetition across ROs in SBFD symbols and legacy ROs in non-SBFD symbols may be enabled based at least in part on several limitations and/or design considerations. One limitation may involve a set of ROs in the non-SBFD symbols and the SBFD symbols having a same starting RB. A constraint may be relaxed in order to enable an RO group formulation with SBFD ROs and legacy ROs with different starting RBs. A first design consideration may involve a configuration of a number of repetitions in the SBFD symbols and the non-SBFD symbols given a different link quality and an expected combining gain of repetitions. For example,

$${N}_{preamble}^{rep} = 4$$

may be

$${N}_{preamble}^{rep - legacy} = 2 and {N}_{preamble}^{rep - SBFD} = 2 , or {N}_{preamble}^{rep - legacy} = 1 and {N}_{preamble}^{rep - SBFD} = 3 ,$$

$$or {N}_{preamble}^{rep - legacy} = 3 and {N}_{preamble}^{rep - SBFD} = 1 ,$$

across the legacy ROs and the SBFD ROs. A second design consideration may involve a determination of a first RO in an RO group across the legacy ROs and the SBFD ROs. A third design consideration may involve a differentiation of SBFD-aware UEs and legacy UEs that are transmitting a preamble with repetitions in shared legacy ROs.

In some examples, by indicating a configuration of RO groups across SBFD symbols and non-SBFD symbols, the UE may be able to transmit RACH transmissions with efficient PRACH repetition. The RO groups in the SBFD symbols and the non-SBFD symbols may have different starting RBs, which may increase a design flexibility. A number of repetitions in the SBFD symbols and a number of repetitions in the non-SBFD symbols may be selected depending on different link qualities and expected combining gains of repetitions of SBFD symbols versus non-SBFD symbols, which may allow numbers of desired repetitions to be more accurately predicted. As a result, the UE and/or the network node may be able to transmit and/or receive RACH transmissions with repetition using RO groups that are efficiently formed across the SBFD symbols and the non-SBFD symbols, thereby improving an overall system performance.

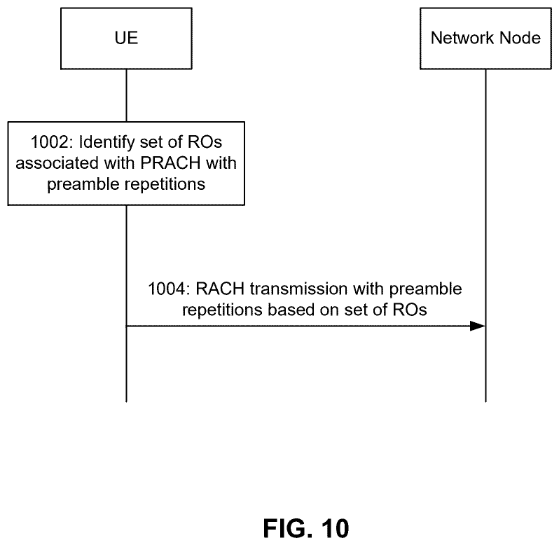

FIG. 10 is a diagram illustrating an example 1000 associated with RO groups across SBFD symbols and non-SBFD symbols, in accordance with the present disclosure. As shown in FIG. 10, example 1000 includes communication between a UE (e.g., UE 120) and a network node (e.g., network node 110). In some aspects, the UE and the network node may be included in a wireless network, such as wireless network 100.

As shown by reference number 1002, the UE may identify a set of ROs associated with a PRACH repetition. The set of ROs may include an SBFD RO associated with one or more SBFD symbols and a non-SBFD RO associated with one or more non-SBFD symbols. The set of ROs may span across the one or more SBFD symbols and the one or more non-SBFD symbols. In some aspects, a starting RB of the SBFD RO may be based at least in part on the non-SBFD RO and the SBFD RO being associated with a same virtual starting RB and a different physical starting RB. In some aspects, the starting RB of the SBFD RO may be based at least in part on an RB offset and a starting RB of the non-SBFD RO. In some aspects, the starting RB of the SBFD RO may be based at least in part on the RB offset and/or a starting RB of the non-SBFD RO, where the starting RB of the SBFD RO may be based at least in part on a modular operation with respect to a number of useable uplink PRBs in an uplink subband.

In some aspects, the set of ROs may include a number of SBFD ROs and a number of non-SBFD ROs. The number of non-SBFD ROs may be at least one half of a total number of ROs in the set of ROs. A repetition of the non-SBFD RO may be counted as one and a repetition of the SBFD RO may be counted as less than one.

In some aspects, the set of ROs may include a number of SBFD ROs and a number of non-SBFD ROs. A number of PRACH preamble repetitions across the one or more SBFD symbols and the one or more non-SBFD symbols may be based at least in part on ROs and non-SBFD ROs. In some aspects, a starting RO of the set of ROs may be a first RO in the number of non-SBFD ROs. The number of non-SBFD ROs may satisfy a threshold. A last RO in the set of ROs may be from the number of SBFD ROs. In some aspects, the set of ROs may include the number of non-SBFD ROs. The number of SBFD ROs may be contained within a span of a set of non-SBFD ROs associated with the number of non-SBFD ROs. The number of SBFD ROs may be based at least in part on a frequency and time order, or the number of SBFD ROs may be based at least in part on a consecutive time order. In some aspects, the set of ROs may be based at least in part on an association or a combination of a set of non-SBFD ROs associated with the number of non-SBFD ROs and a set of SBFD-dedicated ROs associated with the number of SBFD ROs. In some aspects, a starting RO of the set of ROs may be an SBFD RO and a last RO of the set of ROs may be a non-SBFD RO. The SBFD RO may be a first SBFD RO after an end of a set of non-SBFD ROs associated with the number of non-SBFD ROs, or the SBFD RO may be before a start of the set of non-SBFD ROs.

In some aspects, the set of ROs may include one or more sets of SBFD ROs associated with an SBFD-aware UE and one or more sets of non-SBFD ROs associated with a non-SBFD-aware UE. The non-SBFD-aware UE and the SBFD-aware UE may be assigned different sets of preambles based at least in part on a preamble partitioning. In some aspects, the UE may be an SBFD-aware UE. The UE may transmit, to the network node, a UE capability that indicates one or more of: whether the SBFD-aware UE supports a set of ROs in SBFD ROs, or whether the SBFD-aware UE supports a set of ROs across non-SBFD ROs and SBFD ROs.

In some aspects, the UE may receive, from the network node, one shared PRACH configuration that configures SBFD ROs in the one or more SBFD symbols. The UE may receive, from the network node and based at least in part on the one shared PRACH configuration, an indication that indicates that the set of ROs is restricted to the SBFD ROs in addition to a set of non-SBFD ROs, or that the set of ROs is not restricted to the SBFD ROs and is able to be formed across the set of non-SBFD ROs and SBFD ROs. In some aspects, the UE may receive, from the network node, a dedicated PRACH configuration that configures SBFD ROs in the one or more SBFD symbols. The dedicated PRACH configuration may be associated with an SBFD random access. No PRACH repetition may be configured across non-SBFD ROs and the SBFD ROs of the dedicated PRACH configuration.

As shown by reference number 1004, the UE may transmit, to the network node, a RACH transmission with preamble repetitions based at least in part on the set of ROs. The UE may transmit the RACH transmission in accordance with a random access procedure. The UE may transmit the RACH transmission with the preamble repetition using the set of ROs. The UE may transmit the RACH transmission to initiate an access to the network node and/or to establish a connection with the network node.

As indicated above, FIG. 10 is provided as an example. Other examples may differ from what is described with regard to FIG. 10.

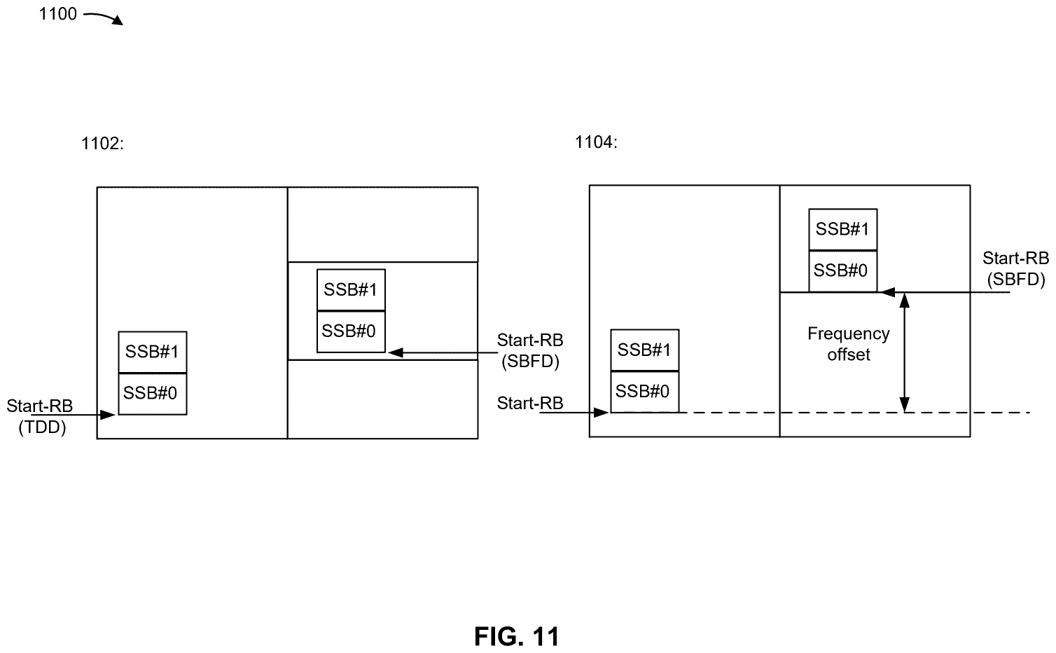

FIG. 11 is a diagram illustrating an example 1100 associated with RO groups across SBFD symbols and non-SBFD symbols, in accordance with the present disclosure.

In some aspects, an

$${N}_{p r e a m b l e}^{rep} PRACH$$

preamble repetition across legacy ROs and SBFD symbols may be based at least in part on a relaxation of starting RBs. For a PRACH repetition in a group of ROs that include the legacy ROs and SBFD ROs, the starting RBs of the SBFD ROs may be determined, such that the legacy ROs and the SBFD ROs have the same virtual starting RB while having different physical starting RBs. For example, a starting RB of an SBFD RO uplink subband may be the Nth RB from first RBs in the uplink subband, and a starting RB of the legacy RO may be the Nth RB in an uplink BWP, where Nis an integer. The starting RBs for the SBFD ROs and the legacy ROs may be with respect to a frequency domain.

As shown by reference number 1102, an RO group may be formed across non-SBFD symbols and SBFD symbols. A starting RB (start-RB) associated with the non-SBFD symbols (TDD) may be the same as a starting RB associated with the SBFD symbols. For example, the starting RB of a legacy RO, associated with the non-SBFD symbols, may be an Nth RB in an uplink BWP (frequency domain). The starting RB of an SBFD RO may also be the Nth RB from first RBs in an uplink subband (frequency domain).

In some aspects, the starting RB of the SBFD ROs (RB_{start-SBFD}) may be determined with an RB offset (RB_{offset-SBFD}) (frequency offset) with respect to the starting RB of legacy ROs (RBₛₜₐᵣₜ), in accordance with:

$$R {B}_{start - SBFD} = ( R {B}_{start} + R {B}_{offset - SBFD} ) .$$

In some aspects, the starting RB of the SBFD ROs (RB_{start-SBFD}) may be determined with a modular operation with respect to a size of an uplink subband (e.g., a number of useable RBs in the uplink subband)

$$( {N}_{UL - SB}^{s i z e} ) .$$

The starting RB may be reinterpreted with respect to a first RB in the uplink subband, in accordance with:

$$R {B}_{start - SBFD} = ( R {B}_{start} ) {N}_{UL - SB}^{s i z e}$$

$$R {B}_{start - SBFD} = ( R {B}_{start} + R {B}_{offset - SBFD} ) mod {N}_{UL - SB}^{s i z e} .$$

As shown by reference number 1104, an RO group may be formed across non-SBFD symbols and SBFD symbols. A starting RB of a legacy RO may be associated with the non-SBFD symbols (TDD), and a starting RB of an SBFD RO may be associated with the SBFD symbols. The starting RB of the legacy RO may be determined with a frequency offset with respect to the starting RB of the SBFD RO. In other words, the starting RB of the legacy RO plus the frequency offset may correspond to the starting RB of the SBFD RO.

As indicated above, FIG. 11 is provided as an example. Other examples may differ from what is described with regard to FIG. 11.

In some aspects, a configuration of RO groups for preamble repetitions across SBFD symbols and non-SBFD symbols may be challenging, given a different link quality and expected combining gains of repetitions. For example,

$${N}_{preamble}^{rep} = 4$$

may be

$${N}_{preamble}^{rep - legacy} = 2 and {N}_{preamble}^{rep - SBFD} = 2 , or {N}_{preamble}^{rep - legacy} = 1 and {N}_{preamble}^{rep - SBFD} = 3 ,$$

$$or {N}_{preamble}^{rep - legacy} and {N}_{preamble}^{rep - SBFD} = 1 ,$$

across legacy ROs and SBFD ROs. An RO group may have a minimum number of legacy ROs (TDD ROs), in addition to the SBFD ROs, to guarantee a minimum quality of PRACH repetition receptions.

In some aspects, regarding a number of SBFD ROs and a number of legacy ROs in an RO group, for

$${N}_{p r e a m b l e}^{rep} PRACH$$

preamble repetition across legacy ROs and SBFD symbols in the RO group that includes N1 legacy ROs and N2 SBFD ROs and

$$( {N}_{preamble}^{rep} = N 1 + N 2 ) ,$$

a number of legacy ROs may be at least

$${N}_{p r e a m b l e}^{r e p} / 2 ,$$

where

$${N}_{preamble}^{rep} ( legacy ) or {N}_{preamble}^{rep - legacy}$$

corresponds to N1 and

$${N}_{p r e a m b l e}^{r e p} ( SBFD ) or {N}_{preamble}^{rep - SBFD}$$

corresponds to N2. A repetition in a legacy RO may be counted as one, while a repetition in an SBFD RO may be counted as less than one given a lower SINR and combining gain in the SBFD RO as compared to the legacy RO. For example, when an uplink SINR of the SBFD RO is −3 dB worse than the legacy RO, one TDD repetition may correspond to two SBFD repetitions. In order for 4 repetitions in legacy ROs to achieve 6 dB, 3 legacy ROs and 2 SBFD ROs may be used (e.g., the 2 SBFD ROs is equivalent to 1 legacy RO, which totals 4 legacy ROs), or 2 legacy ROs and 4 SBFD ROs may be used (e.g., the 4 SBFD ROs is equivalent to 2 legacy ROs, which totals 4 legacy ROs). In this case,

$${N}_{preamble}^{rep}$$

may be interpreted based at least in part on a repetition in the legacy ROs (e.g.,

$${N}_{preamble}^{rep}$$

is a nominal number of repetitions), and an actual number of repetitions (N1+N2) may be variable (N2=N1/k), where k is an integer.

In some aspects, for

$${N}_{p r e a m b l e}^{rep} PRACH$$

preamble repetition across legacy ROs and SBFD symbols in an RO group that includes N1 legacy ROs and N2 SBFD ROs, where

$${N}_{preamble}^{rep} = N 1 + N 2 ,$$

N1 and N2 may be determined. Legacy RO groups may be determined first, and then the RO group may be determined. The RO group may be determined such that a starting RO is a first RO, or the starting RO may be one of the legacy ROs in a legacy RO group. The RO group may have a minimum number of legacy ROs (TDD ROs) to guarantee a minimum quality of PRACH repetition receptions. A number of SBFD ROs (N2) may be determined such that

$${N}_{p r e a m b l e}^{r e p} = {N}_{p r e a m b l e}^{r e p} ( legacy ) + N 2.$$

A last RO in the RO group may be an SBFD RO, which may result in having different RA-RNTIs for SBFD-aware UEs having preamble repetitions and legacy UEs, as an RA-RNTI may be determined by a start symbol of a last valid RO in the RO group.

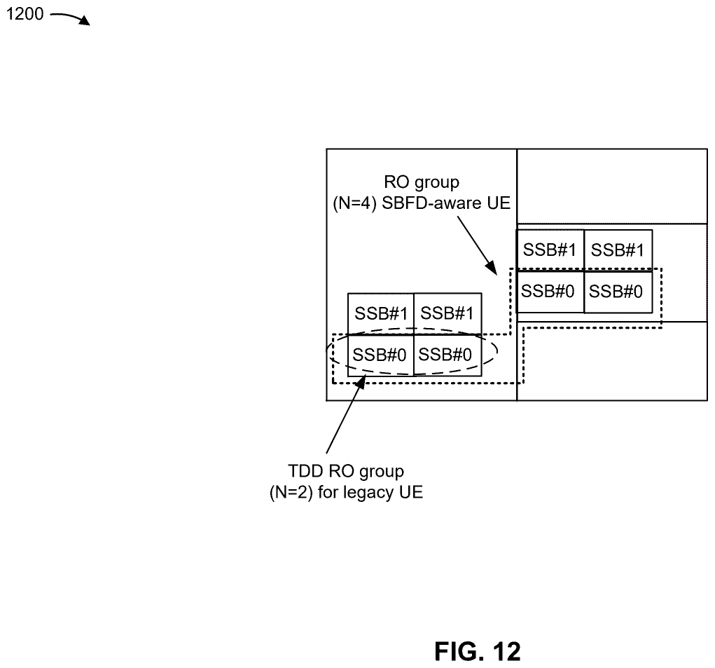

FIG. 12 is a diagram illustrating an example 1200 associated with RO groups across SBFD symbols and non-SBFD symbols, in accordance with the present disclosure.

As shown in FIG. 12, when

$${N}_{preamble}^{rep} = 4 ,$$

a legacy RO group may be determined first, such that

$${N}_{p r e a m b l e}^{rep} ( legacy ) = 2.$$

The legacy RO group may be a TDD RO group

$$( {N}_{preamble}^{rep} = 2 )$$

for a legacy UE. An RO group (mixed RO group) may be determined such that a starting RO is a first RO in the legacy RO group. A number of SBFD ROs (N2) may be determined such that

$${N}_{preamble}^{rep} = {N}_{preamble}^{rep} ( legacy ) + {N}_{p r e a m b l e}^{r e p} ( SBFD )$$

(e.g., N2=2), where N1 corresponds to

$${N}_{preamble}^{rep} ( legacy )$$

and N2 corresponds to

$${N}_{p r e a m b l e}^{r e p} ( SBFD ) .$$

The RO group may be an RO group

$$( {N}_{preamble}^{rep} = 4 )$$

for an SBFD-aware UE. A last RO in the RO group may be an SBFD RO. Further,

$${N}_{preamble}^{rep} = {N}_{preamble}^{rep} ( legacy - R Os ) + {N}_{preamble}^{rep} ( SBFD - ROs ) .$$

As indicated above, FIG. 12 is provided as an example. Other examples may differ from what is described with regard to FIG. 12.

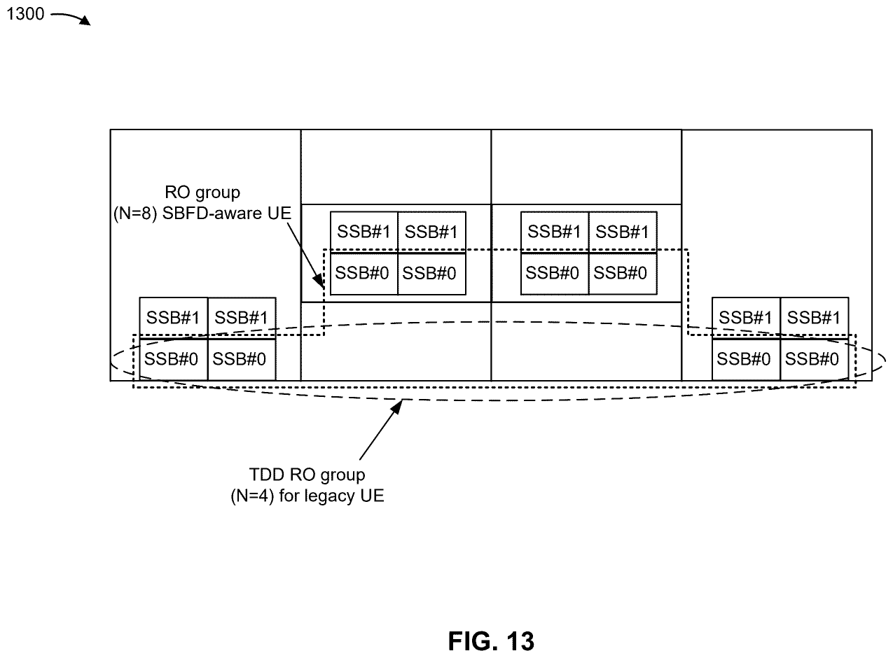

FIG. 13 is a diagram illustrating an example 1300 associated with RO groups across SBFD symbols and non-SBFD symbols, in accordance with the present disclosure.

In some aspects, for

$${N}_{preamble}^{rep} PRACH$$

preamble repetition across legacy ROs and SBFD symbols in an RO group that includes N1 legacy ROs and N2 SBFD ROs, where

$${N}_{preamble}^{rep} = N 1 + N 2 ,$$

N1 and N2 may be determined. Legacy RO groups may be determined first, and then the RO group may be determined. The RO group may be determined such that the RO group contains the legacy RO groups. A number of SBFD ROs (N2) may be determined such that

$${N}_{preamble}^{rep} = {N}_{preamble}^{rep} ( legacy ) + N 2.$$

SBFD ROs may be contained within a span of the legacy RO groups. The SBFD ROs may be determined in order, first in frequency, and then in time. Alternatively, the SBFD ROs may be determined in a consecutive time order.

As shown in FIG. 13, a legacy RO group may be determined first, such that

$${N}_{p r e a m b l e}^{rep} ( legacy ) = 4.$$

The legacy RO group may be a TDD RO group

$$( {N}_{preamble}^{rep} = 4 )$$

for a legacy UE. An RO group (mixed RO group) may be determined that contains the legacy RO group. The RO group (SBFD ROs) may be contained within a span of the legacy RO group. In this example,

$${N}_{preamble}^{rep} = {N}_{preamble}^{rep} ( legacy ) + N 2 = 8 ,$$

### so N2=4.

As indicated above, FIG. 13 is provided as an example. Other examples may differ from what is described with regard to FIG. 13.

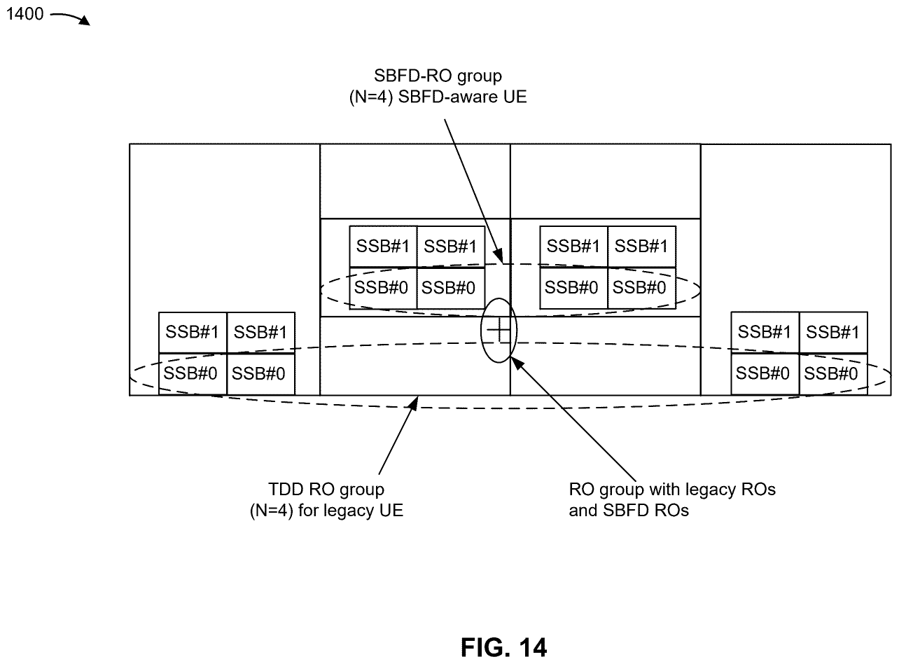

FIG. 14 is a diagram illustrating an example 1400 associated with RO groups across SBFD symbols and non-SBFD symbols, in accordance with the present disclosure.

In some aspects, for

$${N}_{p r e a m b l e}^{rep} PRACH$$

preamble repetition across legacy ROs and SBFD symbols in an RO group that includes N1 legacy ROs and N2 SBFD ROs, where

$${N}_{preamble}^{rep} = N 1 + N 2 ,$$

N1 and N2 may be determined. Legacy RO groups may be determined first, and then an SBFD-dedicated RO group may be determined. The RO group may be determined by associating or combining ROs in two separate RO groups.

As shown in FIG. 14, a legacy RO group may be determined first, such that

$${N}_{p r e a m b l e}^{r e p} ( legacy ) = 4.$$

The legacy RO group may be a TDD RO group

$$( {N}_{preamble}^{rep} = 4 )$$

for a legacy UE. An SBFD-dedicated RO group may be determined next, such that

$${N}_{preamble}^{rep} = 4 .$$

The SBFD-dedicated RO group may be an SBFD RO group

$$( {N}_{preamble}^{rep} = 4 )$$

for an SBFD-aware UE. An RO group (mixed RO group) may be formed by associating or combining the legacy RO group and the SBFD-dedicated RO group, such that the RO group may contain both legacy ROs and SBFD ROs.

As indicated above, FIG. 14 is provided as an example. Other examples may differ from what is described with regard to FIG. 14.

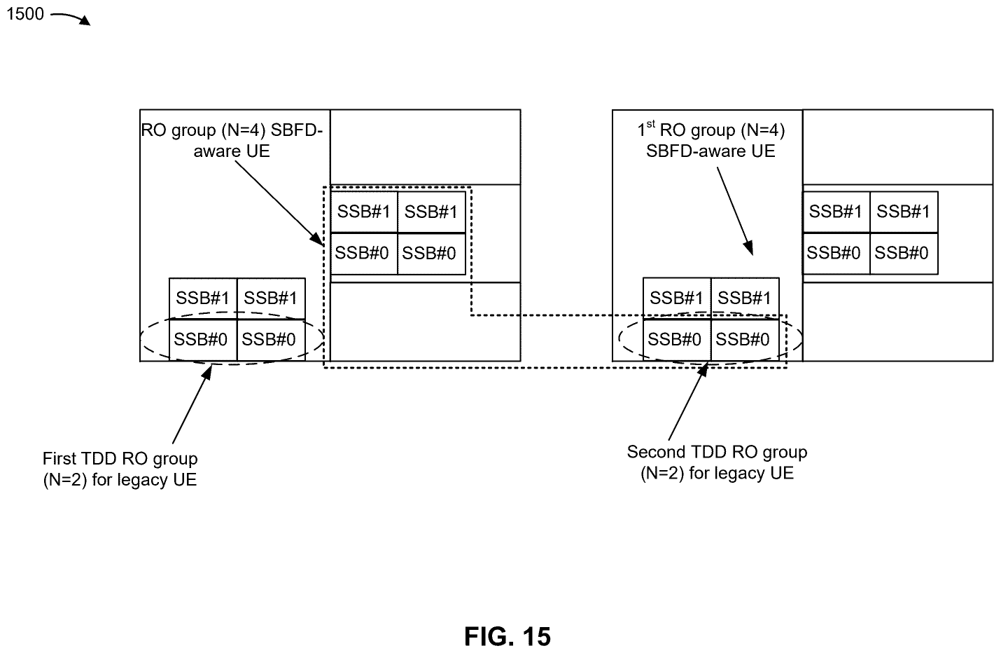

FIG. 15 is a diagram illustrating an example 1500 associated with RO groups across SBFD symbols and non-SBFD symbols, in accordance with the present disclosure.

In some aspects, for

$${N}_{p r e a m b l e}^{rep} PRACH$$

preamble repetition across legacy ROs and SBFD symbols in an RO group that includes N1 legacy ROs and N2 SBFD ROs, where

$${N}_{preamble}^{rep} = N 1 + N 2 ,$$

N1 and N2 may be determined. The RO group (mixed RO group) may be determined such that a starting RO may be an SBFD RO and one or more last ROs may be legacy ROs. The SBFD RO may be a first SBFD RO after an end of a legacy RO group, or the SBFD RO may be an SBFD RO before a start of a legacy RO group.

As shown in FIG. 15, a first legacy RO group and a second legacy RO group may be identified, where each legacy RO group may be a TDD RO group

$$( {N}_{preamble}^{rep} = 2 )$$

for a legacy UE. An RO group may be determined, such that a starting RO is an SBFD RO and last ROs may be associated with the second legacy RO group. The RO group may be an RO group

$$( {N}_{preamble}^{rep} = 4 )$$

for an SBFD-aware UE. The SBFD RO may be a first SBFD RO after an end of the first legacy RO group. The SBFD RO may be a first SBFD RO before a start of the second legacy RO group.

As indicated above, FIG. 15 is provided as an example. Other examples may differ from what is described with regard to FIG. 15.

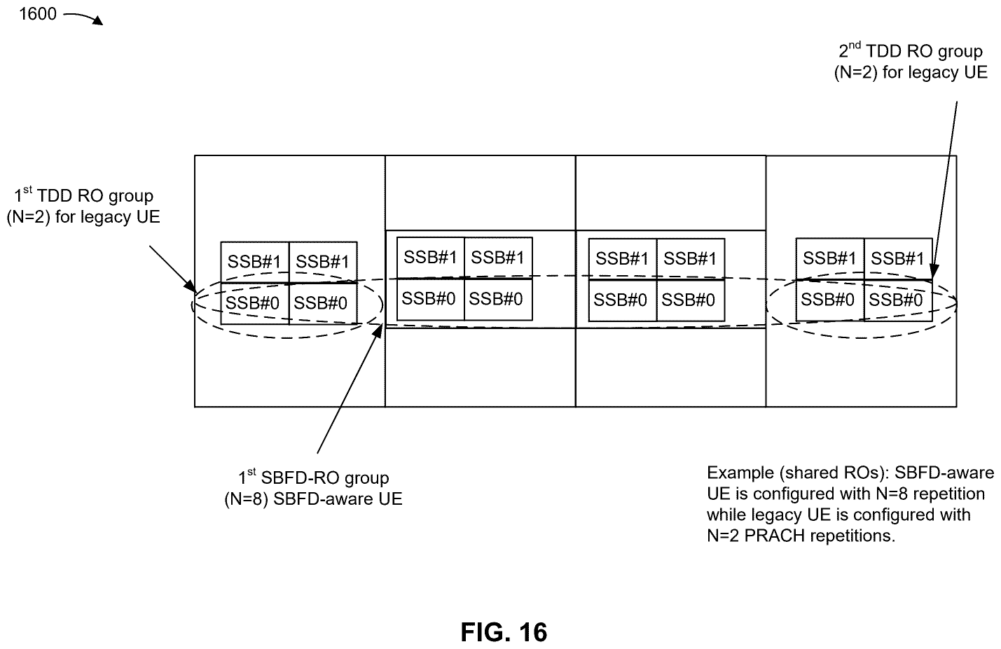

FIG. 16 is a diagram illustrating an example 1600 associated with RO groups across SBFD symbols and non-SBFD symbols, in accordance with the present disclosure.

In some aspects, a set of ROs may be shared between a legacy (TDD) RO group for PRACH repetition and another RO group (e.g., another mixed RO group), where the other RO group may contain a set of SBFD ROs and the legacy RO group. In this example a legacy UE and an SBFD-aware UE may be assigned different sets of preambles (e.g., preamble partitioning in shared legacy ROs). The SBFD-aware UE may use a same preamble index/set in SBFD ROs or may be associated with a different preamble set/index to fully utilize a number of preambles in SBFD ROs (e.g., relax a condition of a same preamble for PRACH repetition). The SBFD-aware UE and the legacy UE may utilize different RA-RNTIs by having a last RO in an RO group as a TDD RO and an SBFD RO, respectively. As a result, a differentiation of the legacy UE and the SBFD-aware UE may be achieved.

As shown in FIG. 16, a first legacy RO group and a second legacy RO group may be identified, where each legacy RO group may be a TDD RO group

$$( {N}_{preamble}^{rep} = 2 )$$

for a legacy UE. An RO group

$$( {N}_{preamble}^{rep} = 8 )$$

for an SBFD-aware UE may be determined. The RO group may include the first legacy RO group and the second legacy RO group. In other words, the RO group may include a first set of SBFD ROs, a second set of SBFD ROs, the first legacy RO group, and the second legacy RO group. In this example, the SBFD-aware UE may be configured with

$${N}_{preamble}^{rep} = 8$$

repetitions, while the legacy UE may be configured with

$${N}_{preamble}^{rep} = 2$$

repetitions. The legacy UE and the SBFD-aware UE may be assigned different sets of preambles based at least in part on a preamble partitioning.

As indicated above, FIG. 16 is provided as an example. Other examples may differ from what is described with regard to FIG. 16.

In some aspects, in a first RACH configuration, a UE may have a same preamble format and same PRACH parameters/configurations for SBFD RO and legacy ROs (TDD ROs), which may result in no overhead to an RO group across legacy/SBFD ROs. In a second RACH configuration, the UE may need to switch RACH configurations (e.g., preamble, format, and/or power). A legacy RO may be associated with a legacy RACH configuration. An SBFD RO may be associated with an additional RACH configuration with a different preamble, power control parameter, and/or association period.

In some aspects, for PRACH repetitions across SBFD ROs and legacy ROs, when a network node has configured a single/shared RACH configuration, the network node may indicate that an RO group is restricted to SBFD ROs in addition to a legacy RO group, or the network node may indicate that an RO group is not restricted to SBFD ROs and that the RO group is able to be formed across legacy ROs and SBFD ROs. The network node may provide such an indication via an RRC configuration or a system information block (SIB).

In some aspects, for PRACH repetitions across SBFD ROs and legacy ROs, when the network node additional configures a separate dedicated RACH configuration for an SBFD random access, no PRACH repetition may be employed across legacy ROs of a legacy RACH configuration and SBFD ROs of an SBFD-dedicated RACH configuration as a default. In other words, an RO group may be restricted to span all SBFD ROs (additional ROs), in addition to a legacy RO group spanning legacy ROs. The network node may configure, via one or more RRC parameters, that such an RO group is to be across SBFD ROs and legacy ROs (e.g., by using similar RACH parameters as used for an additional RACH configuration). In some aspects, an absence of an RRC parameter may indicate that an RO group is only within a same RO type.

In some aspects, a UE, such as an SBFD-aware UE, may report, to a network node, an indication of a UE capability. The SBFD-aware UE may report whether the SBFD-aware UE supports an RO group in SBFD ROs (separate capability than a PRACH repetition in legacy ROs). The SBFD-aware UE may report whether the SBFD-aware UE supports an RO group across legacy ROs and SBFD ROs. The SBFD-aware UE may perform such UE capability reporting separately for each RACH configuration (e.g., a first RACH configuration and/or a second RACH configuration) that is supported by the SBFD-aware UE.

In some aspects, for a PRACH repetition in SBFD symbols with the first RACH configuration, a UE capability report may include a first component, a second component, and/or a third component. The first component may indicate a support of the first RACH transmission at additional-ROs in SBFD symbols without a preamble repetition. The second component may indicate a support of a PRACH transmission with preamble repetition within an RO group of SBFD ROs (additional ROs) only. The third component may indicate a support of a PRACH transmission with preamble repetition within an RO group across combination of legacy ROs and SBFD ROs.

In some aspects, for a PRACH repetition in SBFD symbols with the second RACH configuration, a UE capability report may include a first component, a second component, and/or a third component. The first component may indicate a support of the second RACH configuration without a PRACH repetition. The second component may indicate a support of a PRACH repetition within an RO group within SBFD ROs (additional ROs) only. The third component may indicate a support of a PRACH repetition within an RO group across legacy ROs and SBFD ROs.

FIG. 17 is a diagram illustrating an example process 1700 performed, for example, at a UE or an apparatus of a UE, in accordance with the present disclosure. Example process 1700 is an example where the apparatus or the UE (e.g., UE 120) performs operations associated with RO groups across SBFD symbols and non-SBFD symbols.

As shown in FIG. 17, in some aspects, process 1700 may include identifying a set of ROs associated with a PRACH with preamble repetitions in the set of ROs, wherein: the set of ROs include an SBFD RO associated with one or more SBFD symbols and a non-SBFD RO associated with one or more non-SBFD symbols, and the set of ROs span across the one or more SBFD symbols and the one or more non-SBFD symbols (block 1710). For example, the UE (e.g., using communication manager 1906, depicted in FIG. 19) may identify a set of ROs associated with a PRACH with preamble repetitions in the set of ROs, wherein: the set of ROs include an SBFD RO associated with one or more SBFD symbols and a non-SBFD RO associated with one or more non-SBFD symbols, and the set of ROs span across the one or more SBFD symbols and the one or more non-SBFD symbols, as described above.

As further shown in FIG. 17, in some aspects, process 1700 may include transmitting a RACH transmission with preamble repetitions based at least in part on the set of ROs (block 1720). For example, the UE (e.g., using transmission component 1904 and/or communication manager 1906, depicted in FIG. 19) may transmit a RACH transmission with preamble repetitions based at least in part on the set of ROs, as described above.

Process 1700 may include additional aspects, such as any single aspect or any combination of aspects described below and/or in connection with one or more other processes described elsewhere herein.

In a first aspect, a starting RB of the SBFD RO is based at least in part on the non-SBFD RO and the SBFD RO being associated with a same virtual starting RB and a different physical starting RB.

In a second aspect, alone or in combination with the first aspect, a starting RB of the SBFD RO is based at least in part on an RB offset and a starting RB of the non-SBFD RO.

In a third aspect, alone or in combination with one or more of the first and second aspects, a starting RB of the SBFD RO is based at least in part on one or more of an RB offset and a starting RB of the non-SBFD RO, and the starting RB of the SBFD RO is based at least in part on a modular operation with respect to a number of useable uplink PRBs in an uplink subband.

In a fourth aspect, alone or in combination with one or more of the first through third aspects, the set of ROs include a number of SBFD ROs and a number of non-SBFD ROs, wherein the number of non-SBFD ROs is at least one half of a total number of ROs in the set of ROs, and wherein a repetition of the non-SBFD RO is counted as one and a repetition of the SBFD RO is counted as less than one.

In a fifth aspect, alone or in combination with one or more of the first through fourth aspects, the set of ROs include a number of SBFD ROs and a number of non-SBFD ROs, and wherein a number of PRACH preamble repetitions across the one or more SBFD symbols and the one or more non-SBFD symbols is based at least in part on SBFD ROs and non-SBFD ROs.

In a sixth aspect, alone or in combination with one or more of the first through fifth aspects, a starting RO of the set of ROs is a first RO in the number of non-SBFD ROs, the number of non-SBFD ROs satisfies a threshold, and a last RO in the set of ROs is from the number of SBFD ROs.

In a seventh aspect, alone or in combination with one or more of the first through sixth aspects, the set of ROs include the number of non-SBFD ROs, the number of SBFD ROs are contained within a span of a set of non-SBFD ROs associated with the number of non-SBFD ROs, and the number of SBFD ROs are based at least in part on a frequency and time order, or the number of SBFD ROs are based at least in part on a consecutive time order.

In an eighth aspect, alone or in combination with one or more of the first through seventh aspects, the set of ROs is based at least in part on an association or a combination of a set of non-SBFD ROs associated with the number of non-SBFD ROs and a set of SBFD-dedicated ROs associated with the number of SBFD ROs.

In a ninth aspect, alone or in combination with one or more of the first through eighth aspects, a starting RO of the set of ROs is an SBFD RO and a last RO of the set of ROs is a non-SBFD RO, and the SBFD RO is a first SBFD RO after an end of a set of non-SBFD ROs associated with the number of non-SBFD ROs, or the SBFD RO is before a start of the set of non-SBFD ROs.

In a tenth aspect, alone or in combination with one or more of the first through ninth aspects, the set of ROs include one or more sets of SBFD ROs associated with an SBFD-aware UE and one or more sets of non-SBFD ROs associated with a non-SBFD-aware UE, and wherein the non-SBFD-aware UE and the SBFD-aware UE are assigned different sets of preambles based at least in part on a preamble partitioning.

In an eleventh aspect, alone or in combination with one or more of the first through tenth aspects, process 1700 includes receiving one shared PRACH configuration that configures SBFD ROs in the one or more SBFD symbols, and receiving, based at least in part on the one shared PRACH configuration, an indication that indicates that the set of ROs is restricted to the SBFD ROs in addition to a set of non-SBFD ROs, or that the set of ROs is not restricted to the SBFD ROs and is able to be formed across the set of non-SBFD ROs and SBFD ROs.

In a twelfth aspect, alone or in combination with one or more of the first through eleventh aspects, process 1700 includes receiving a dedicated PRACH configuration that configures SBFD ROs in the one or more SBFD symbols, wherein the dedicated PRACH configuration is associated with an SBFD random access, wherein no PRACH repetition is configured across non-SBFD ROs and the SBFD ROs of the dedicated PRACH configuration.

In a thirteenth aspect, alone or in combination with one or more of the first through twelfth aspects, the UE is an SBFD-aware UE, and process 1700 includes transmitting a UE capability that indicates one or more of: whether the SBFD-aware UE supports a set of ROs in SBFD ROs, or whether the SBFD-aware UE supports a set of ROs across non-SBFD ROs and SBFD ROs.

Although FIG. 17 shows example blocks of process 1700, in some aspects, process 1700 may include additional blocks, fewer blocks, different blocks, or differently arranged blocks than those depicted in FIG. 17. Additionally, or alternatively, two or more of the blocks of process 1700 may be performed in parallel.

FIG. 18 is a diagram illustrating an example process 1800 performed, for example, at a network node or an apparatus of a network node, in accordance with the present disclosure. Example process 1800 is an example where the apparatus or the network node (e.g., network node 110) performs operations associated with RO groups across SBFD symbols and non-SBFD symbols.

As shown in FIG. 18, in some aspects, process 1800 may include transmitting a capability signaling (block 1810). For example, the network node (e.g., using transmission component 2004 and/or communication manager 2006, depicted in FIG. 20) may transmit a capability signaling, as described above.

As further shown in FIG. 18, in some aspects, process 1800 may include receiving, based at least in part on the capability signaling, a RACH transmission with preamble repetitions based at least in part on a set of ROs, wherein: the set of ROs are associated with a PRACH with preamble repetitions in the set of ROs; the set of ROs include an SBFD RO associated with one or more SBFD symbols and a non-SBFD RO associated with one or more non-SBFD symbols, and the set of ROs span across the one or more SBFD symbols and the one or more non-SBFD symbols (block 1820). For example, the network node (e.g., using reception component 2002 and/or communication manager 2006, depicted in FIG. 20) may receive, based at least in part on the capability signaling, a RACH transmission with preamble repetitions based at least in part on a set of ROs, wherein: the set of ROs are associated with a PRACH with preamble repetitions in the set of ROs; the set of ROs include an SBFD RO associated with one or more SBFD symbols and a non-SBFD RO associated with one or more non-SBFD symbols, and the set of ROs span across the one or more SBFD symbols and the one or more non-SBFD symbols, as described above.

Process 1800 may include additional aspects, such as any single aspect or any combination of aspects described below and/or in connection with one or more other processes described elsewhere herein.

In a first aspect, a starting RB of the SBFD RO is based at least in part on the non-SBFD RO and the SBFD RO being associated with a same virtual starting RB and a different physical starting RB.

In a second aspect, alone or in combination with the first aspect, a starting RB of the SBFD RO is based at least in part on an RB offset and a starting RB of the non-SBFD RO.

In a third aspect, alone or in combination with one or more of the first and second aspects, a starting RB of the SBFD RO is based at least in part on one or more of an RB offset and a starting RB of the non-SBFD RO, and the starting RB of the SBFD RO is based at least in part on a modular operation with respect to a number of useable uplink PRBs in an uplink subband.

In a fourth aspect, alone or in combination with one or more of the first through third aspects, the set of ROs include a number of SBFD ROs and a number of non-SBFD ROs, wherein the number of non-SBFD ROs is at least one half of a total number of ROs in the set of ROs, and wherein a repetition of the non-SBFD RO is counted as one and a repetition of the SBFD RO is counted as less than one.

In a fifth aspect, alone or in combination with one or more of the first through fourth aspects, the set of ROs include a number of SBFD ROs and a number of non-SBFD ROs, and wherein a number of PRACH preamble repetitions across the one or more SBFD symbols and the one or more non-SBFD symbols is based at least in part on SBFD ROs and non-SBFD ROs.

In a sixth aspect, alone or in combination with one or more of the first through fifth aspects, a starting RO of the set of ROs is a first RO in the number of non-SBFD ROs, the number of non-SBFD ROs satisfies a threshold, and a last RO in the set of ROs is from the number of SBFD ROs.

In a seventh aspect, alone or in combination with one or more of the first through sixth aspects, the set of ROs include the number of non-SBFD ROs, the number of SBFD ROs are contained within a span of a set of non-SBFD ROs associated with the number of non-SBFD ROs, and the number of SBFD ROs are based at least in part on a frequency and time order, or the number of SBFD ROs are based at least in part on a consecutive time order.

In an eighth aspect, alone or in combination with one or more of the first through seventh aspects, the set of ROs is based at least in part on an association or a combination of a set of non-SBFD ROs associated with the number of non-SBFD ROs and a set of SBFD-dedicated ROs associated with the number of SBFD ROs.

In a ninth aspect, alone or in combination with one or more of the first through eighth aspects, a starting RO of the set of ROs is an SBFD RO and a last RO of the set of ROs is a non-SBFD RO, and the SBFD RO is a first SBFD RO after an end of a set of non-SBFD ROs associated with the number of non-SBFD ROs, or the SBFD RO is before a start of the set of non-SBFD ROs.

In a tenth aspect, alone or in combination with one or more of the first through ninth aspects, the set of ROs include one or more sets of SBFD ROs associated with an SBFD-aware UE and one or more sets of non-SBFD ROs associated with a non-SBFD-aware UE, and wherein the non-SBFD-aware UE and the SBFD-aware UE are assigned different sets of preambles based at least in part on a preamble partitioning.

In an eleventh aspect, alone or in combination with one or more of the first through tenth aspects, process 1700 includes transmitting one shared PRACH configuration that configures SBFD ROs in the one or more SBFD symbols, and transmitting, based at least in part on the one shared PRACH configuration, an indication that indicates that the set of ROs is restricted to the SBFD ROs in addition to a set of non-SBFD ROs, or that the set of ROs is not restricted to the SBFD ROs and is able to be formed across the set of non-SBFD ROs and SBFD ROs.

In a twelfth aspect, alone or in combination with one or more of the first through eleventh aspects, process 1700 includes transmitting a dedicated PRACH configuration that configures SBFD ROs in the one or more SBFD symbols, wherein the dedicated PRACH configuration is associated with an SBFD random access, wherein no PRACH repetition is configured across non-SBFD ROs and the SBFD ROs of the dedicated PRACH configuration.

In a thirteenth aspect, alone or in combination with one or more of the first through twelfth aspects, the UE is an SBFD-aware UE, and process 1700 includes receiving a UE capability that indicates one or more of: whether the SBFD-aware UE supports a set of ROs in SBFD ROs, or whether the SBFD-aware UE supports a set of ROs across non-SBFD ROs and SBFD ROs.

Although FIG. 18 shows example blocks of process 1800, in some aspects, process 1800 may include additional blocks, fewer blocks, different blocks, or differently arranged blocks than those depicted in FIG. 18. Additionally, or alternatively, two or more of the blocks of process 1800 may be performed in parallel.

FIG. 19 is a diagram of an example apparatus 1900 for wireless communication, in accordance with the present disclosure. The apparatus 1900 may be a UE, or a UE may include the apparatus 1900. In some aspects, the apparatus 1900 includes a reception component 1902, a transmission component 1904, and/or a communication manager 1906, which may be in communication with one another (for example, via one or more buses and/or one or more other components). In some aspects, the communication manager 1906 is the communication manager 150 described in connection with FIG. 1. As shown, the apparatus 1900 may communicate with another apparatus 1908, such as a UE or a network node (such as a CU, a DU, an RU, or a base station), using the reception component 1902 and the transmission component 1904. The communication manager 1906 may be included in, or implemented via, a processing system (for example, the processing system 140 described in connection with FIG. 1) of the UE.

In some aspects, the apparatus 1900 may be configured to perform one or more operations described herein in connection with FIGS. 10-16. Additionally, or alternatively, the apparatus 1900 may be configured to perform one or more processes described herein, such as process 1700 of FIG. 17, or a combination thereof. In some aspects, the apparatus 1900 and/or one or more components shown in FIG. 19 may include one or more components of the UE described in connection with FIG. 1. Additionally, or alternatively, one or more components shown in FIG. 19 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1902 may receive communications, such as reference signals, control information, data communications, or a combination thereof, from the apparatus 1908. The reception component 1902 may provide received communications to one or more other components of the apparatus 1900. In some aspects, the reception component 1902 may perform signal processing on the received communications, and may provide the processed signals to the one or more other components of the apparatus 1900. In some aspects, the reception component 1902 may include one or more components of the UE described above in connection with FIG. 1, such as a radio, one or more RF chains, one or more transceivers, or one or more modems, each of which may in turn be coupled with one or more antennas of the UE.

The transmission component 1904 may transmit communications, such as reference signals, control information, data communications, or a combination thereof, to the apparatus 1908. In some aspects, one or more other components of the apparatus 1900 may generate communications and may provide the generated communications to the transmission component 1904 for transmission to the apparatus 1908. In some aspects, the transmission component 1904 may perform signal processing on the generated communications, and may transmit the processed signals to the apparatus 1908. In some aspects, the transmission component 1904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1904 may be co-located with the reception component 1902.

The communication manager 1906 may support operations of the reception component 1902 and/or the transmission component 1904. For example, the communication manager 1906 may receive information associated with configuring reception of communications by the reception component 1902 and/or transmission of communications by the transmission component 1904. Additionally, or alternatively, the communication manager 1906 may generate and/or provide control information to the reception component 1902 and/or the transmission component 1904 to control reception and/or transmission of communications.

The communication manager 1906 may identify a set of ROs associated with a PRACH with preamble repetitions in the set of ROs, wherein: the set of ROs include an SBFD RO associated with one or more SBFD symbols and a non-SBFD RO associated with one or more non-SBFD symbols, and the set of ROs span across the one or more SBFD symbols and the one or more non-SBFD symbols. The transmission component 1904 may transmit a RACH transmission with preamble repetitions based at least in part on the set of ROs.

The reception component 1902 may receive one shared PRACH configuration that configures SBFD ROs in the one or more SBFD symbols. The reception component 1902 may receive, based at least in part on the one shared PRACH configuration, an indication that indicates that the set of ROs is restricted to the SBFD ROs in addition to a set of non-SBFD ROs, or that the set of ROs is not restricted to the SBFD ROs and is able to be formed across the set of non-SBFD ROs and SBFD ROs. The reception component 1902 may receive a dedicated PRACH configuration that configures SBFD ROs in the one or more SBFD symbols, wherein the dedicated PRACH configuration is associated with an SBFD random access, and no PRACH repetition is configured across non-SBFD ROs and the SBFD ROs of the dedicated PRACH configuration.

The number and arrangement of components shown in FIG. 19 are provided as an example. In practice, there may be additional components, fewer components, different components, or differently arranged components than those shown in FIG. 19. Furthermore, two or more components shown in FIG. 19 may be implemented within a single component, or a single component shown in FIG. 19 may be implemented as multiple, distributed components. Additionally, or alternatively, a set of (one or more) components shown in FIG. 19 may perform one or more functions described as being performed by another set of components shown in FIG. 19.

FIG. 20 is a diagram of an example apparatus 2000 for wireless communication, in accordance with the present disclosure. The apparatus 2000 may be a network node, or a network node may include the apparatus 2000. In some aspects, the apparatus 2000 includes a reception component 2002, a transmission component 2004, and/or a communication manager 2006, which may be in communication with one another (for example, via one or more buses and/or one or more other components). In some aspects, the communication manager 2006 is the communication manager 155 described in connection with FIG. 1. As shown, the apparatus 2000 may communicate with another apparatus 2008, such as a UE or a network node (such as a CU, a DU, an RU, or a base station), using the reception component 2002 and the transmission component 2004. The communication manager 2006 may be included in, or implemented via, a processing system (for example, the processing system 145 described in connection with FIG. 1) of the network node.

In some aspects, the apparatus 2000 may be configured to perform one or more operations described herein in connection with FIGS. 10-16. Additionally, or alternatively, the apparatus 2000 may be configured to perform one or more processes described herein, such as process 1800 of FIG. 18, or a combination thereof. In some aspects, the apparatus 2000 and/or one or more components shown in FIG. 20 may include one or more components of the network node described in connection with FIG. 1. Additionally, or alternatively, one or more components shown in FIG. 20 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 2002 may receive communications, such as reference signals, control information, data communications, or a combination thereof, from the apparatus 2008. The reception component 2002 may provide received communications to one or more other components of the apparatus 2000. In some aspects, the reception component 2002 may perform signal processing on the received communications, and may provide the processed signals to the one or more other components of the apparatus 2000. In some aspects, the reception component 2002 may include one or more components of the network node described above in connection with FIG. 1, such as a radio, one or more RF chains, one or more transceivers, or one or more modems, each of which may in turn be coupled with one or more antennas of the network node. In some aspects, the reception component 2002 and/or the transmission component 2004 may include or may be included in a network interface. The network interface may be configured to obtain and/or output signals for the apparatus 2000 via one or more communications links, such as a backhaul link, a midhaul link, and/or a fronthaul link.

The transmission component 2004 may transmit communications, such as reference signals, control information, data communications, or a combination thereof, to the apparatus 2008. In some aspects, one or more other components of the apparatus 2000 may generate communications and may provide the generated communications to the transmission component 2004 for transmission to the apparatus 2008. In some aspects, the transmission component 2004 may perform signal processing on the generated communications, and may transmit the processed signals to the apparatus 2008. In some aspects, the transmission component 2004 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 2004 may be co-located with the reception component 2002.

The communication manager 2006 may support operations of the reception component 2002 and/or the transmission component 2004. For example, the communication manager 2006 may receive information associated with configuring reception of communications by the reception component 2002 and/or transmission of communications by the transmission component 2004. Additionally, or alternatively, the communication manager 2006 may generate and/or provide control information to the reception component 2002 and/or the transmission component 2004 to control reception and/or transmission of communications.

The transmission component 2004 may transmit a capability signaling. The reception component 2002 may receive, based at least in part on the capability signaling, a RACH transmission with preamble repetitions based at least in part on a set of ROs, wherein: the set of ROs are associated with a PRACH with preamble repetitions in the set of ROs; the set of ROs include an SBFD RO associated with one or more SBFD symbols and a non-SBFD RO associated with one or more non-SBFD symbols, and the set of ROs span across the one or more SBFD symbols and the one or more non-SBFD symbols.

The transmission component 2004 may transmit one shared PRACH configuration that configures SBFD ROs in the one or more SBFD symbols. The transmission component 2004 may transmit, based at least in part on the one shared PRACH configuration, an indication that indicates that the set of ROs is restricted to the SBFD ROs in addition to a set of non-SBFD ROs, or that the set of ROs is not restricted to the SBFD ROs and is able to be formed across the set of non-SBFD ROs and SBFD ROs. The transmission component 2004 may transmit a dedicated PRACH configuration that configures SBFD ROs in the one or more SBFD symbols, wherein the dedicated PRACH configuration is associated with an SBFD random access, and no PRACH repetition is configured across non-SBFD ROs and the SBFD ROs of the dedicated PRACH configuration.

The number and arrangement of components shown in FIG. 20 are provided as an example. In practice, there may be additional components, fewer components, different components, or differently arranged components than those shown in FIG. 20. Furthermore, two or more components shown in FIG. 20 may be implemented within a single component, or a single component shown in FIG. 20 may be implemented as multiple, distributed components. Additionally, or alternatively, a set of (one or more) components shown in FIG. 20 may perform one or more functions described as being performed by another set of components shown in FIG. 20.

The following provides an overview of some Aspects of the present disclosure:
Aspect 1: A method of wireless communication performed by a user equipment (UE), comprising: identifying a set of random access channel (RACH) occasions (ROs) associated with a physical random access channel (PRACH) with preamble repetitions in the set of ROs, wherein: the set of ROs include a subband full duplex (SBFD) RO associated with one or more SBFD symbols and a non-SBFD RO associated with one or more non-SBFD symbols, and the set of ROs span across the one or more SBFD symbols and the one or more non-SBFD symbols; and transmitting a RACH transmission with preamble repetitions based at least in part on the set of ROs.
Aspect 2: The method of Aspect 1, wherein a starting resource block (RB) of the SBFD RO is based at least in part on the non-SBFD RO and the SBFD RO being associated with a same virtual starting RB and a different physical starting RB.
Aspect 3: The method of any of Aspects 1-2, wherein a starting resource block (RB) of the SBFD RO is based at least in part on an RB offset and a starting RB of the non-SBFD RO.
Aspect 4: The method of any of Aspects 1-3, wherein a starting resource block (RB) of the SBFD RO is based at least in part on one or more of an RB offset and a starting RB of the non-SBFD RO, and wherein the starting RB of the SBFD RO is based at least in part on a modular operation with respect to a number of useable uplink physical resource blocks (PRBs) in an uplink subband.
Aspect 5: The method of any of Aspects 1-4, wherein the set of ROs include a number of SBFD ROs and a number of non-SBFD ROs, wherein the number of non-SBFD ROs is at least one half of a total number of ROs in the set of ROs, and wherein a repetition of the non-SBFD RO is counted as one and a repetition of the SBFD RO is counted as less than one.
Aspect 6: The method of any of Aspects 1-5, wherein the set of ROs include a number of SBFD ROs and a number of non-SBFD ROs, and wherein a number of PRACH preamble repetitions across the one or more SBFD symbols and the one or more non-SBFD symbols is based at least in part on SBFD ROs and non-SBFD ROs.
Aspect 7: The method of Aspect 6, wherein: a starting RO of the set of ROs is a first RO in the number of non-SBFD ROs; the number of non-SBFD ROs satisfies a threshold; and a last RO in the set of ROs is from the number of SBFD ROs.
Aspect 8: The method of Aspect 6, wherein: the set of ROs include the number of non-SBFD ROs; the number of SBFD ROs are contained within a span of a set of non-SBFD ROs associated with the number of non-SBFD ROs; and the number of SBFD ROs are based at least in part on a frequency and time order, or the number of SBFD ROs are based at least in part on a consecutive time order.
Aspect 9: The method of Aspect 6, wherein the set of ROs is based at least in part on an association or a combination of a set of non-SBFD ROs associated with the number of non-SBFD ROs and a set of SBFD-dedicated ROs associated with the number of SBFD ROs.
Aspect 10: The method of Aspect 6, wherein: a starting RO of the set of ROs is an SBFD RO and a last RO of the set of ROs is a non-SBFD RO; and the SBFD RO is a first SBFD RO after an end of a set of non-SBFD ROs associated with the number of non-SBFD ROs, or the SBFD RO is before a start of the set of non-SBFD ROs.
Aspect 11: The method of any of Aspects 1-10, wherein the set of ROs include one or more sets of SBFD ROs associated with an SBFD-aware UE and one or more sets of non-SBFD ROs associated with a non-SBFD-aware UE, and wherein the non-SBFD-aware UE and the SBFD-aware UE are assigned different sets of preambles based at least in part on a preamble partitioning.
Aspect 12: The method of any of Aspects 1-11, further comprising: receiving one shared PRACH configuration that configures SBFD ROs in the one or more SBFD symbols; and receiving, based at least in part on the one shared PRACH configuration, an indication that indicates that the set of ROs is restricted to the SBFD ROs in addition to a set of non-SBFD ROs, or that the set of ROs is not restricted to the SBFD ROs and is able to be formed across the set of non-SBFD ROs and SBFD ROs.
Aspect 13: The method of any of Aspects 1-12, further comprising: receiving a dedicated PRACH configuration that configures SBFD ROs in the one or more SBFD symbols, wherein the dedicated PRACH configuration is associated with an SBFD random access, wherein no PRACH repetition is configured across non-SBFD ROs and the SBFD ROs of the dedicated PRACH configuration.
Aspect 14: The method of any of Aspects 1-13, wherein the UE is an SBFD-aware UE, and further comprising: transmitting a UE capability that indicates one or more of: whether the SBFD-aware UE supports a set of ROs in SBFD ROs, or whether the SBFD-aware UE supports a set of ROs across non-SBFD ROs and SBFD ROs.
Aspect 15: A method of wireless communication performed by a network node, comprising: transmitting a capability signaling; and receiving, based at least in part on the capability signaling, a random access channel (RACH) transmission with preamble repetitions based at least in part on a set of RACH occasions (ROs), wherein: the set of ROs are associated with a physical random access channel (PRACH) with preamble repetitions in the set of ROs; the set of ROs include a subband full duplex (SBFD) RO associated with one or more SBFD symbols and a non-SBFD RO associated with one or more non-SBFD symbols, and the set of ROs span across the one or more SBFD symbols and the one or more non-SBFD symbols.
Aspect 16: The method of Aspect 15, wherein a starting resource block (RB) of the SBFD RO is based at least in part on the non-SBFD RO and the SBFD RO being associated with a same virtual starting RB and a different physical starting RB.
Aspect 17: The method of any of Aspects 15-16, wherein a starting resource block (RB) of the SBFD RO is based at least in part on an RB offset and a starting RB of the non-SBFD RO.
Aspect 18: The method of any of Aspects 15-17, wherein a starting resource block (RB) of the SBFD RO is based at least in part on one or more of an RB offset and a starting RB of the non-SBFD RO, and wherein the starting RB of the SBFD RO is based at least in part on a modular operation with respect to a number of useable uplink physical resource blocks (PRBs) in an uplink subband.
Aspect 19: The method of any of Aspects 15-18, wherein the set of ROs include a number of SBFD ROs and a number of non-SBFD ROs, wherein the number of non-SBFD ROs is at least one half of a total number of ROs in the set of ROs, and wherein a repetition of the non-SBFD RO is counted as one and a repetition of the SBFD RO is counted as less than one.
Aspect 20: The method of any of Aspects 15-19, wherein the set of ROs include a number of SBFD ROs and a number of non-SBFD ROs, and wherein a number of PRACH preamble repetitions across the one or more SBFD symbols and the one or more non-SBFD symbols is based at least in part on SBFD ROs and non-SBFD ROs.
Aspect 21: The method of Aspect 20, wherein: a starting RO of the set of ROs is a first RO in the number of non-SBFD ROs; the number of non-SBFD ROs satisfies a threshold; and a last RO in the set of ROs is from the number of SBFD ROs.
Aspect 22: The method of Aspect 20, wherein: the set of ROs include the number of non-SBFD ROs; the number of SBFD ROs are contained within a span of a set of non-SBFD ROs associated with the number of non-SBFD ROs; and the number of SBFD ROs are based at least in part on a frequency and time order, or the number of SBFD ROs are based at least in part on a consecutive time order.
Aspect 23: The method of Aspect 20, wherein the set of ROs is based at least in part on an association or a combination of a set of non-SBFD ROs associated with the number of non-SBFD ROs and a set of SBFD-dedicated ROs associated with the number of SBFD ROs.
Aspect 24: The method of Aspect 20, wherein: a starting RO of the set of ROs is an SBFD RO and a last RO of the set of ROs is a non-SBFD RO; and the SBFD RO is a first SBFD RO after an end of a set of non-SBFD ROs associated with the number of non-SBFD ROs, or the SBFD RO is before a start of the set of non-SBFD ROs.
Aspect 25: The method of any of Aspects 15-24, wherein the set of ROs include one or more sets of SBFD ROs associated with an SBFD-aware UE and one or more sets of non-SBFD ROs associated with a non-SBFD-aware UE, and wherein the non-SBFD-aware UE and the SBFD-aware UE are assigned different sets of preambles based at least in part on a preamble partitioning.
Aspect 26: The method of any of Aspects 15-25, further comprising: transmitting one shared PRACH configuration that configures SBFD ROs in the one or more SBFD symbols; and transmitting, based at least in part on the one shared PRACH configuration, an indication that indicates that the set of ROs is restricted to the SBFD ROs in addition to a set of non-SBFD ROs, or that the set of ROs is not restricted to the SBFD ROs and is able to be formed across the set of non-SBFD ROs and SBFD ROs.
Aspect 27: The method of any of Aspects 15-26, further comprising: transmitting a dedicated PRACH configuration that configures SBFD ROs in the one or more SBFD symbols, wherein the dedicated PRACH configuration is associated with an SBFD random access, wherein no PRACH repetition is configured across non-SBFD ROs and the SBFD ROs of the dedicated PRACH configuration.
Aspect 28: The method of any of Aspects 15-27, wherein a user equipment (UE) is an SBFD-aware UE, and further comprising: receiving a UE capability that indicates one or more of: whether the SBFD-aware UE supports a set of ROs in SBFD ROs, or whether the SBFD-aware UE supports a set of ROs across non-SBFD ROs and SBFD ROs.
Aspect 29: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-28.
Aspect 30: An apparatus for wireless communication at a device, the apparatus comprising one or more memories and one or more processors coupled to the one or more memories, the one or more processors configured to cause the device to perform the method of one or more of Aspects 1-28.
Aspect 31: An apparatus for wireless communication, the apparatus comprising at least one means for performing the method of one or more of Aspects 1-28.
Aspect 32: A non-transitory computer-readable medium storing code for wireless communication, the code comprising instructions executable by one or more processors to perform the method of one or more of Aspects 1-28.
Aspect 33: A non-transitory computer-readable medium storing a set of instructions for wireless communication, the set of instructions comprising one or more instructions that, when executed by one or more processors of a device, cause the device to perform the method of one or more of Aspects 1-28.
Aspect 34: A device for wireless communication, the device comprising a processing system that includes one or more processors and one or more memories coupled with the one or more processors, the processing system configured to cause the device to perform the method of one or more of Aspects 1-28.
Aspect 35: An apparatus for wireless communication at a device, the apparatus comprising one or more memories and one or more processors coupled to the one or more memories, the one or more processors individually or collectively configured to cause the device to perform the method of one or more of Aspects 1-28.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a +b+c, as well as any combination with multiples of the same element (for example, a +a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, which, individually or in any combination, are operable to cause the apparatus to:
identify a set of random access channel (RACH) occasions (ROs) associated with a physical random access channel (PRACH) with preamble repetitions in the set of ROs, wherein:
the set of ROs include a subband full duplex (SBFD) RO associated with one or more SBFD symbols and a non-SBFD RO associated with one or more non-SBFD symbols, and
the set of ROs span across the one or more SBFD symbols and the one or more non-SBFD symbols; and
transmit a RACH transmission with preamble repetitions based at least in part on the set of ROs.

2. The apparatus of claim 1, wherein a starting resource block (RB) of the SBFD RO is based at least in part on the non-SBFD RO and the SBFD RO being associated with a same virtual starting RB and a different physical starting RB.

3. The apparatus of claim 1, wherein a starting resource block (RB) of the SBFD RO is based at least in part on an RB offset and a starting RB of the non-SBFD RO.

4. The apparatus of claim 1, wherein a starting resource block (RB) of the SBFD RO is based at least in part on one or more of an RB offset and a starting RB of the non-SBFD RO, and wherein the starting RB of the SBFD RO is based at least in part on a modular operation with respect to a number of useable uplink physical resource blocks (PRBs) in an uplink subband.

5. The apparatus of claim 1, wherein the set of ROs include a number of SBFD ROs and a number of non-SBFD ROs, wherein the number of non-SBFD ROs is at least one half of a total number of ROs in the set of ROs, and wherein a repetition of the non-SBFD RO is counted as one and a repetition of the SBFD RO is counted as less than one.

6. The apparatus of claim 1, wherein the set of ROs include a number of SBFD ROs and a number of non-SBFD ROs, and wherein a number of PRACH preamble repetitions across the one or more SBFD symbols and the one or more non-SBFD symbols is based at least in part on SBFD ROs and non-SBFD ROs.

7. The apparatus of claim 6, wherein:
a starting RO of the set of ROs is a first RO in the number of non-SBFD ROs;
the number of non-SBFD ROs satisfies a threshold; and
a last RO in the set of ROs is from the number of SBFD ROs.

8. The apparatus of claim 6, wherein:
the set of ROs include the number of non-SBFD ROs;
the number of SBFD ROs are contained within a span of a set of non-SBFD ROs associated with the number of non-SBFD ROs; and
the number of SBFD ROs are based at least in part on a frequency and time order, or the number of SBFD ROs are based at least in part on a consecutive time order.

9. The apparatus of claim 6, wherein the set of ROs is based at least in part on an association or a combination of a set of non-SBFD ROs associated with the number of non-SBFD ROs and a set of SBFD-dedicated ROs associated with the number of SBFD ROs.

10. The apparatus of claim 6, wherein:
a starting RO of the set of ROs is an SBFD RO and a last RO of the set of ROs is a non-SBFD RO; and
the SBFD RO is a first SBFD RO after an end of a set of non-SBFD ROs associated with the number of non-SBFD ROs, or the SBFD RO is before a start of the set of non-SBFD ROs.

11. The apparatus of claim 1, wherein the set of ROs include one or more sets of SBFD ROs associated with an SBFD-aware UE and one or more sets of non-SBFD ROs associated with a non-SBFD-aware UE, and wherein the non-SBFD-aware UE and the SBFD-aware UE are assigned different sets of preambles based at least in part on a preamble partitioning.

12. The apparatus of claim 1, wherein the one or more processors, individually or in any combination, are operable to further cause the apparatus to:
receive one shared PRACH configuration that configures SBFD ROs in the one or more SBFD symbols; and
receive, based at least in part on the one shared PRACH configuration, an indication that indicates that the set of ROs is restricted to the SBFD ROs in addition to a set of non-SBFD ROs, or that the set of ROs is not restricted to the SBFD ROs and is able to be formed across the set of non-SBFD ROs and SBFD ROs.

13. The apparatus of claim 1, wherein the one or more processors, individually or in any combination, are operable to further cause the apparatus to:
receive a dedicated PRACH configuration that configures SBFD ROs in the one or more SBFD symbols, wherein the dedicated PRACH configuration is associated with an SBFD random access,
wherein no PRACH repetition is configured across non-SBFD ROs and the SBFD ROs of the dedicated PRACH configuration.

14. The apparatus of claim 1, wherein the UE is an SBFD-aware UE, and wherein the one or more processors, individually or in any combination, are operable to further cause the apparatus to:
transmit a UE capability that indicates one or more of: whether the SBFD-aware UE supports a set of ROs in SBFD ROs, or whether the SBFD-aware UE supports a set of ROs across non-SBFD ROs and SBFD ROs.

15. An apparatus for wireless communication at a network node, comprising:
one or more memories; and
one or more processors, coupled to the one or more memories, which, individually or in any combination, are operable to cause the apparatus to:
transmit a capability signaling; and
receive, based at least in part on the capability signaling, a random access channel (RACH) transmission with preamble repetitions based at least in part on a set of RACH occasions (ROs), wherein:
the set of ROs are associated with a physical random access channel (PRACH) with preamble repetitions in the set of ROs;
the set of ROs include a subband full duplex (SBFD) RO associated with one or more SBFD symbols and a non-SBFD RO associated with one or more non-SBFD symbols, and
the set of ROs span across the one or more SBFD symbols and the one or more non-SBFD symbols.

16. The apparatus of claim 15, wherein:
a starting resource block (RB) of the SBFD RO is based at least in part on the non-SBFD RO and the SBFD RO being associated with a same virtual starting RB and a different physical starting RB;
the starting RB of the SBFD RO is based at least in part on an RB offset and a starting RB of the non-SBFD RO; or
the starting RB of the SBFD RO is based at least in part on one or more of an RB offset and a starting RB of the non-SBFD RO, and the starting RB of the SBFD RO is based at least in part on a modular operation with respect to a number of useable uplink physical resource blocks (PRBs) in an uplink subband.

17. The apparatus of claim 15, wherein the one or more processors, individually or in any combination, are operable to further cause the apparatus to:
transmit one shared PRACH configuration that configures SBFD ROs in the one or more SBFD symbols; and
transmit, based at least in part on the one shared PRACH configuration, an indication that indicates that the set of ROs is restricted to the SBFD ROs in addition to a set of non-SBFD ROs, or that the set of ROs is not restricted to the SBFD ROs and is able to be formed across the set of non-SBFD ROs and SBFD ROs.

18. The apparatus of claim 15, wherein the one or more processors, individually or in any combination, are operable to further cause the apparatus to:
transmit a dedicated PRACH configuration that configures SBFD ROs in the one or more SBFD symbols, wherein the dedicated PRACH configuration is associated with an SBFD random access,
wherein no PRACH repetition is configured across non-SBFD ROs and the SBFD ROs of the dedicated PRACH configuration.

19. The apparatus of claim 15, wherein a user equipment (UE) is an SBFD-aware UE, and wherein the one or more processors, individually or in any combination, are operable to further cause the apparatus to:
receive a UE capability that indicates one or more of: whether the SBFD-aware UE supports a set of ROs in SBFD ROs, or whether the SBFD-aware UE supports a set of ROs across non-SBFD ROs and SBFD ROs.

20. A method of wireless communication performed by a user equipment (UE), comprising:
identifying a set of random access channel (RACH) occasions (ROs) associated with a physical random access channel (PRACH) with preamble repetitions in the set of ROs, wherein:
the set of ROs include a subband full duplex (SBFD) RO associated with one or more SBFD symbols and a non-SBFD RO associated with one or more non-SBFD symbols, and
the set of ROs span across the one or more SBFD symbols and the one or more non-SBFD symbols; and
transmitting a RACH transmission with preamble repetitions based at least in part on the set of ROs.
